(19) United States
(12) Patent Application Publication
(10) Pub. No.: US 2026/0215401 A1
(43) Pub. Date: Jul. 30, 2026

(54) SYSTEMS AND METHODS FOR THE CULTIVATION AND HARVESTING OF AQUATIC ANIMALS

(71) Applicant: Rudder Industrial Holdings, LLC, Portland, ME (US)

(72) Inventors: Matthew Jordan ODLIN, Freeport, ME (US); Stephen ZADESKY, Portola Valley, CA (US); Nathaniel MERRILL, Portland, ME (US); Samuel WOOLF, Brunswick, ME (US); Phillip CONNAUGHTON, Somerville, MA (US); Nicholas HAGLER, Harpswell, ME (US); MArgaux MARTIN-FILIPPI, Lone Tree, CO (US)

(21) Appl. No.: 19/573,461

(22) Filed: Mar. 20, 2026

Related U.S. Application Data
(63) Continuation of application No. 18/226,636, filed on Jul. 26, 2023, now abandoned.
Application No. 18/226,636 is a continuation of application No. PCT/US2021/062899, filed on Dec. 10, 2021.
(60) Provisional application No. 63/143,496, filed on Jan. 29, 2021.

(51) Int. Cl. A01K 61/90; G06M 7/00; G06V 10/764; G06V 10/774; G06V 10/82; G06V 40/10

(52) U.S. Cl. CPC A01K 61/90; G06M 7/00; G06V 10/764; G06V 10/774; G06V 10/82; G06V 40/10

(57) ABSTRACT

Embodiments described herein relate generally to systems that can include an optical sensor configured to generate image data associated with a set of aquatic animals, a memory, and a processor operatively coupled to the memory and the optical sensor. The processor can be configured to receive the image data associated with the set of aquatic animals, determine a set of characteristics associated with the set of aquatic animals based on the image data using a machine learning model, and classify each aquatic animal in the set of aquatic animals based on the set of characteristics using the machine learning model. The processor further configured to count at least a subset of the aquatic animals based on the classification.

### CROSS-REFERENCE TO RELATED APPLICATIONS

This application is a continuation U.S. patent application Ser. No. 18/226,636, filed Jul. 26, 2023, which is a continuation of International Patent Application No. PCT/US2021/062899, filed Dec. 10, 2021, entitled “Systems and Methods for the Cultivation and Harvesting of Aquatic Animals,” which claims priority to and the benefit of U.S. Provisional Application No. 63/143,496, filed Jan. 29, 2021, entitled “Systems and Methods for the Cultivation and Harvesting of Aquatic Animals,” the disclosure of each of which is incorporated herein by reference in its entirety.

### BACKGROUND

Embodiments described herein relate to farming aquatic animals and more particularly to systems and methods for cultivating, transferring, grading, and harvesting aquatic animals in a cultivation system.

Farming of aquatic animals, or aquaculture, can be a sustainable and environmentally friendly approach to producing protein-rich sources of food. Aquatic animals, for example animals of the phylum Mollusca, such as oysters, clams, mussels, scallops, bivalves, and/or the like can be cultivated by placing the aquatic animals at the bottom of a body of water where they can grow under natural conditions similar to those encountered in the wild. Shortcomings of this approach, however, can include the loss of aquatic animals due to fluctuating water currents, attack by predators, and/or suffocation if buried in mud. Moreover, harvesting the aquatic animals typically involves dredging, which is a time-consuming and labor-intensive process limited to relatively shallow water environments and/or coastal areas.

Alternatively, aquatic animals can be cultivated using a series of enclosures, such as upwelling systems, cages, racks, or bags, suspended in water. While these approaches may provide some protection to the aquatic animals during development, a single type of enclosure is typically used for only a portion of the development cycle. It is common practice to move developing aquatic animals between multiple enclosures during development, which also can be expensive and labor-intensive. Accordingly, a need exists for improved systems and methods for cultivating and harvesting aquatic animals cultivated in cultivation systems.

### SUMMARY

Embodiments described herein relate generally to systems and methods for cultivating and harvesting aquatic animals. In some embodiments, a system includes an optical sensor, a memory, and a processor operatively coupled to the memory and the optical sensor. The optical sensor configured to generate image data associated with a set of aquatic animals. The processor configured to receive the image data associated with the set of aquatic animals. The processor configured to execute a machine learning model to determine a set of characteristics associated with the set of aquatic animals based on the image data and to classify each aquatic animal in the set of aquatic animals based on the set of characteristics. The processor further configured to count at least a subset of the aquatic animals based on the classification.

In some embodiments, the machine learning model can be and/or can include one or more of a deep learning model, faster region-based convolutional neural network (Faster R-CNN), single shot detector (SSD), and/or combinations thereof. In some embodiments, processor can be configured to receive training image data representing multiple images of aquatic animals (e.g., the same type of aquatic animals depicted in the image data) and using the training image data, can train the machine learning model for high recall.

In some embodiments, the image data can represent at least one image depicting the set of aquatic animals and determining the set of characteristics associated with the aquatic animals can include identifying an aquatic animal depicted along a boundary of the image. In some embodiments, the system can further include a contact sensor configured to generate a contact data associated with the set of aquatic animals. The contact sensor is operatively coupled to the processor such that the processor can receive the contact data from the contact sensor. In some implementations, the set of characteristics associated with the set of aquatic animals can be determined based on each of the image data and the contact data.

In some embodiments, the optical sensor may include one or more of a scanner, optical counter, light blocking counter, light scattering counter, direct imaging counter, or camera. In some embodiments, the optical sensor may be coupled to a conveyor configured to convey the set of aquatic animals from a collection device to at least one tank. In some instances, the image data includes multiple images depicting at least a portion of the set of aquatic animals as the set of aquatic animals are moved along the conveyor.

In some embodiments, the set of characteristics associated with the set of aquatic animals can be and/or can include one or more of mortality, health, developmental stage, quantity, size, shape, geometry, weight, and/or combinations thereof. In some embodiments, each aquatic animal in the subset of aquatic animals has a common classification. In some instances, at least one aquatic animal in the set of aquatic animals has a size smaller than about 1 centimeters (cm). In some embodiments, the set of aquatic animals is a set of aquatic animals from an aquaculture system, the system being implemented on a vessel configured to transfer the set of aquatic animals from the aquaculture system to a grading/sorting system of the vessel.

In some embodiments, a method may include receiving, at a processor, image data associated with a set of aquatic animals. The image data can be generated by an optical sensor included in a grading system. The processor can execute a machine learning model to determine a set of characteristics associated with the set of aquatic animals based on the image data and to classify each aquatic animal in the set of aquatic animals based on the set of characteristics. The method further includes counting at least a subset of the aquatic animals based on the classification.

In some embodiments, processor can be configured to receive training image data representing multiple images of aquatic animals (e.g., the same type of aquatic animals depicted in the image data) and using the training image data, can train the machine learning model for high recall. In some embodiments, the image data includes multiple image frames collectively forming a video depicting the set of aquatic animals. In some embodiments, the image data can represent at least one image depicting the set of aquatic animals and determining the set of characteristics associated with the aquatic animals can include identifying an aquatic animal depicted along a boundary of the image.

In some embodiments, an apparatus can include a collection system, a sensor, and a controller. The collection system can be configured to engage an aquaculture system to transfer a set of aquatic animals from the aquaculture system to a grading/sorting system of the apparatus configured to sort the set of aquatic animals. The sensor can be configured to generate sensor data associated with a subset of aquatic animals after being sorted by the grading/sorting system. The controller is operatively coupled to the collection system, the grading/sorting system, and the sensor. The controller can include a processor and a memory. The processor can be configured to execute a machine learning model to determine a set of characteristics associated with the subset of aquatic animals based on the sensor data and to classify each aquatic animal in the subset of aquatic animals based on the set of characteristics. The processor is further configured to count at least a portion of the subset of aquatic animals based on the classification.

In some embodiments, the set of characteristics can include one or more of mortality, health, developmental stage, quantity, size, shape, geometry, weight, and/or combinations thereof. In some embodiments, the set of characteristics is a first set of characteristics and the grading/sorting system includes a sorting device configured to sort the set of aquatic animals received from the collection system based at least in part on a second set of characteristics.

In some embodiments, the collection system can be configured to transfer the set of aquatic animals from a bin of the aquaculture system to a hopper of the grading/sorting system. In some embodiments, the collection system can include one or more of an arm, an arm support, a crane, an actuator, end effector, and/or combinations thereof. In some embodiments, the grading/sorting system can include an isolator element configured to dampen vibrations generated by the grading/sorting system during its operation. In some embodiments, the subset of aquatic animals has at least one common characteristic from the second set of characteristics. In some embodiments, the portion of the subset of aquatic animals has a common classification.

In some embodiments, a cultivation system can include an aquaculture system for cultivating aquatic animals and a service vessel that facilitates accessing the aquatic animals contained in the aquaculture system for harvesting. The aquaculture system can include a frame, a bin, a pumping mechanism, at least one buoyancy tank, and an anchoring system. The frame can be configured to mechanically support various components of the aquaculture system. The bin can be removably coupled to the frame. The bin can be configured to be at least partially disposed in a body of water and to at least temporarily store aquatic animals during development. The pumping mechanism can be coupled to the frame and can be configured to provide a first flow of water through the bin when in a first state and a second flow of water through the bin when in a second state. The first flow of water can have a first direction and the second flow of water can have a second direction different from the first direction. At least one buoyancy tank can be coupled to the frame and can be configured to place the bin in a desired position in the body of water. The anchoring system can be used to restrict movement of the various components of the aquaculture system within the body of water. The service vessel can include a collection system for transferring aquatic animals between the aquaculture system and the service vessel, a grading/sorting system for grading, sorting, and/or sampling aquatic animals based on one or more characteristics, a series of tanks for at least temporarily storing selected aquatic animals, a power system configured to supply power to the various components of the service vessel and/or the aquaculture system, and a control system configured to control one or more components of the service vessel and/or the aquaculture systems.

### BRIEF DESCRIPTION OF THE DRAWINGS

FIG. 1 is a schematic block diagram of a cultivation system including an aquaculture system and a service vessel, according to an embodiment, and illustrating details of the aquaculture system.

FIG. 2A is a schematic block diagram of the cultivation system of FIG. 1 and illustrating details of the service vessel.

FIG. 2B is a schematic block diagram of a grading/sorting system and control system included in the service vessel of FIG. 2A.

FIGS. 3-6 are a perspective view, a side view, a top view, and a cross-sectional view, respectively, of a cultivation system including an aquaculture system and a service vessel, according to an embodiment.

FIGS. 7 and 8 are a perspective view and a top view, respectively, of the aquaculture system included in the cultivation system of FIG. 3.

FIG. 9 is a perspective view of a portion of the aquaculture system of FIG. 7 illustrating a pair of frame assemblies and a set of bins removably coupled thereto.

FIG. 10 is an exploded perspective view of a removable bin included in the aquaculture system of FIG. 7.

FIGS. 11A-11C are each a side view of the aquaculture system of FIG. 7 in a growing position, a submerged position, and a drying position, respectively.

FIG. 12 is a top view of the service vessel included in the cultivation system of FIG. 3 and shown without a front wheelhouse and disposed in an operative position relative to the aquaculture system

FIGS. 13-15 are a front perspective view, a rear perspective view, and a side perspective view of the service vessel of FIG. 12 shown without the front wheelhouse to illustrate a collection system, a grading/sorting system, and a set of holding tanks thereof.

FIGS. 16-18 are a rear perspective view, a front perspective view, and a top view, respectively, of at least a portion of the grading/sorting system of FIG. 13

FIG. 19 is a side perspective view of a counter/scanner and conveyer included in the grading/sorting system of FIG. 13.

FIG. 20 is a schematic diagram of a portion of a grading/sorting system, according to an embodiment.

FIGS. 21A and 21B are examples of images generated by an optical sensor included in the grading/sorting system of FIG. 20 and illustrating a process of boundary object detection.

FIGS. 22A and 22B are schematic diagrams of the portion of the grading/sorting system of FIG. 20, in use, according to an implementation.

FIGS. 23A and 23B are schematic diagrams of the portion of the grading/sorting system of FIG. 20, in use, according to an implementation.

FIGS. 24A and 24B are examples of images generated by an optical sensor included in the grading/sorting system of FIG. 20 and illustrating a process of object detection.

FIG. 25 is a flowchart of a method of classifying aquatic animals, according to an embodiment.

### DETAILED DESCRIPTION

Aquaculture is the farming of various aquatic species including fish, crustaceans, mollusks, aquatic plants, algae, and other organisms. Compared to the farming of livestock, aquaculture can be a more sustainable and environmentally friendly approach to producing protein-rich sources of food. In the aquaculture of aquatic animals, for example, animals of the phylum Mollusca, including but not limited to oysters, clams, mussels, and scallops, cultivation typically starts with larvae attached to a surface (e.g., spat). The spat is placed in an environment where nutrient-rich water flows across the spat, thus feeding the larvae. Over time, the larvae can continue to feed until maturing into an adult mollusk sufficient for harvesting.

One conventional approach to cultivating mollusks involves placing the mollusks on a bed located at the bottom of a body of water where the mollusks can grow naturally, similar to wild mollusks. However, in this approach, mollusks can be vulnerable to predators, can be buried under mud at the bottom of the body of water causing suffocation, and can be moved to deeper waters by water currents, which can all result in the loss of mollusks. Additionally, mollusks grown in this manner are typically harvested by dredging, which can be time consuming, labor intensive, and limited to shallow water environments.

In another approach, mollusks can be grown using a series of enclosures (e.g., upwelling systems, cages, racks, or bags) suspended in a body of water during different stages of mollusk development. The enclosures can provide greater protection from predators and reduce the number of mollusks lost to the environment. For example, an upwelling system, which can be a container with an inlet and an outlet coupled to a pump to facilitate the flow of water, is typically used during the early stages of developing mollusks. Upwelling systems can protect the mollusks and can better control environmental conditions during development. However, once the mollusks grow to a certain size, the mollusks are typically transferred (e.g., moved) to a larger upwelling system, a cage, a bag, or a rack to facilitate further development. The use of multiple enclosures in this manner can be expensive and labor intensive, particularly since mollusks are transferred (e.g., moved) between multiple enclosures over the course of development. As a result, this approach is generally restricted near shore, where water conditions (e.g., tidal conditions, wind, and ocean currents) are less severe and thus, the enclosure can be more easily accessed for operation and maintenance.

Therefore, it is desirable for a cultivation system to have an enclosure that can protect the aquatic animals from predators, contain the aquatic animals to reduce loss to the environment, and can be used during a substantial portion of the development cycle of a mollusk, preferably from spat to a fully matured adult mollusk. A cultivation system exhibiting these features can simplify the cultivation of aquatic animals by reducing the number of enclosures used, thus reducing cost and labor compared to previous approaches. Additionally, a cultivation system that is self-contained in this manner does need to be accessed as frequently. Thus, the cultivation system can be operated for long periods of time without human intervention. This can allow for the deployment of the cultivation system in a deep water environment where the quality of water is generally better compared to water near shore due to lower pollution and stronger water circulation, the risk of disease is reduced since aquaculture systems can be separated farther apart, and the greater depths can allow the cultivation system to be submerged (e.g., fully submerged) during storm conditions to avoid damage to the system.

For example, a cultivation system can include a bin configured to be disposed in a body of water and configured to at least temporarily store aquatic animals during development. A control system can be configured to receive electric power from a power source and provide electric power to a pumping mechanism coupled to the bin such that the pumping mechanism provides a flow of water through the bin. A set of buoyancy tanks can be coupled to the bin. A vessel can be configured to selectively engage and interact with the bin. The vessel can include a collection system to transfer aquatic animals between the bin and the vessel, a grading/sorting system to grade, sort, count, and/or sample the aquatic animals based on one or more predetermined characteristic(s), and a set of storage tanks that can receive the aquatic animals from the grading/sorting system and at least temporarily store the aquatic animals.

In some implementations, cultivation systems deployed in deep water environments can include a service vessel configured to facilitate examining, sorting, transferring, and/or harvesting the aquatic animals. The service vessel can include a control system that can be used to monitor, automate, and/or control one or more processes and/or systems used for farming operations as well as for harvesting operations. In some implementations, the control system can include and/or can be executed on a compute device or controller physically disposed on the service vessel. In some implementations, the control system can include and/or can be executed on a compute device or controller that is remote and/or otherwise not physically disposed on the servicing vessel. In some implementations, the service vessel can be used with one or more aquaculture systems and can be configured to stay with and/or otherwise remain in an operative arrangement with the aquaculture system during the development of the aquatic animals. In some such implementations, the service vessel can be configured to provide electric power to one or more portions of the aquaculture system. Moreover, the control system of the service vessel can direct the electric power to the one or more portions of the aquaculture system and/or otherwise can be configured to control the one or more portions of the aquaculture system.

The present disclosure is thus directed towards a cultivation system configured to support the cultivation and harvesting of aquatic animals. The cultivation system can include an aquaculture system that has one or more connected containers to protect and contain the aquatic animals during development, and a service vessel that is configured to examine, inspect, transfer and/or harvest the aquatic animals contained in the aquaculture system. The aquaculture system can be modular such that the size and/or number of containers can be changed. The depth of the aquaculture system can also be controllably adjusted to accommodate various conditions such as growing, drying, and/or protection during storm conditions. The cultivation system can also be deployed in a deep-water environment with power, control, and/or communication systems to facilitate operation of without direct human intervention. In particular, the cultivation system can include the power, control, and/or communications systems, which can be used to monitor and/or remotely control the cultivation system (e.g., automatically or by a human operator). In some implementations, such power, control, and/or communications systems can be included in, for example, the service vessel and configured to power, control, and/or communicate with one or more portions of the service vessel, the aquaculture system, and/or any other suitable system.

In addition, the present disclosure is also directed to systems, devices, and methods for grading, sorting, identifying, classifying, counting, etc. aquatic animals based on a predicted and/or determined set of characteristics (e.g., mortality, health, developmental stage, quantity, distribution, size, shape, geometry, and weight). These systems, devices, and methods may receive and process image data using one or more signal processing and/or machine learning (e.g., computer vision, deep learning) techniques for predicting and/or determining characteristics of a set of aquatic animals and/or the individual aquatic animals included in that set. In some embodiments, image data comprising a large number of moving (e.g., on a conveyor belt) and highly dense small objects (that commonly clump and/or overlap) may be processed with high recall in a wet environment where every object or substantially every object in an image is correctly detected (e.g., identified).

One or more of the characteristics may be predicted and/or determined using, for example, a machine learning model, computer vision, and/or the like. The set of aquatic animals may be classified and/or identified based on the predicted and/or determined characteristics and the set of aquatic animals can be counted based at least in part on the classification. Furthermore, a continuous and/or real-time status of a population of aquatic animals may be used to inform cultivation and/or harvesting parameters.

By contrast, conventional methods of counting aquatic animals such as a mollusk (e.g., shellfish, bivalves, etc.) using thermal imaging, lasers, mechanical sorting, weight, volume, manual counting, and/or the like are unreliable, inefficient, and/or cost-prohibitive due to the difficulty of counting large numbers of highly dense small objects having a low thermal signature in a wet environment. Furthermore, some known weight and volume based counting methods are inaccurate due to the variable size of aquaculture and added weight of water. For example, conventional methods of counting oysters generally cannot identify and/or have notable challenges with identifying oysters smaller than about 1 centimeter (cm) because of clumping due to surface tension.

Moreover, some known machine learning models, computer vision models, and/or other artificial intelligence (AI) models may not be well suited for counting such aquatic animals. For example, machine leaning and/or computer vision models typically use two performance metrics associated with pattern recognition and/or classification—precision and recall. “Precision” generally refers to a fraction of the relevant elements to retrieved elements. “Recall” generally refers to a fraction of the relevant elements that were retrieved to the total relevant elements. By way of example, an image can depict 10 oysters and 15 non-oyster elements. In this example, a model processes the image and identifies seven positive elements, of which five are oysters (true positives) and two are non-oyster elements (false positives); five oysters were missed (false negatives); and 13 non-oyster elements were correctly excluded (true negatives). As such, the precision of this model is 5/7 (true positives/total positives) and the recall of this model is 5/10 (true positives/total number of relevant elements). In general, training of machine learning and/or computer vision models tends to focus increasing precision. In contrast, the machine learning and/or computer vision models described herein can be trained to increase recall associated with identifying target aquatic animals (e.g., oysters).

As used in this specification and in the claims, the singular forms “a,” “an,” and “the” include plural referents unless the context clearly dictates otherwise. Thus, for example, the term “a member” is intended to mean a single member or a combination of members, “a material” is intended to mean one or more materials or a combination thereof, etc.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

As used herein, the phrase “and/or,” should be understood to mean “either or both” of the elements so conjoined (e.g., elements that are conjunctively present in some cases and disjunctively present in other cases). Multiple elements listed with “and/or” should be construed in the same fashion (e.g., “one or more” of the elements so conjoined). Other elements may optionally be present other than the elements specifically identified by the “and/or” clause, whether related or unrelated to those elements specifically identified. Thus, as a non-limiting example, a reference to “A and/or B”, when used in conjunction with open-ended language such as “including,” “comprising,” etc., can refer, in one implementation, to A only (optionally including elements other than B); in another implementation, to B only (optionally including elements other than A); and in yet another implementation, to both A and B (optionally including other elements).

As used herein, the term “or” should be understood to have the same meaning as “and/or” as defined above. For example, when separating items in a list, “or” or “and/or” shall be interpreted as being inclusive (e.g., the inclusion of at least one, but also including more than one) of a number or list of elements, and, optionally, additional unlisted items.

As used herein, the term “set” can refer to multiple features or a singular feature with multiple parts. For example, when referring to a set of walls, the set of walls can be considered as one wall with multiple portions, or the set of walls can be considered as multiple, distinct walls. Thus, a monolithically constructed item can include a set of walls. Such a set of walls may include multiple portions that are either continuous or discontinuous from each other. A set of walls can also be fabricated from multiple items that are produced separately and are later joined together (e.g., via a weld, an adhesive, or any suitable method).

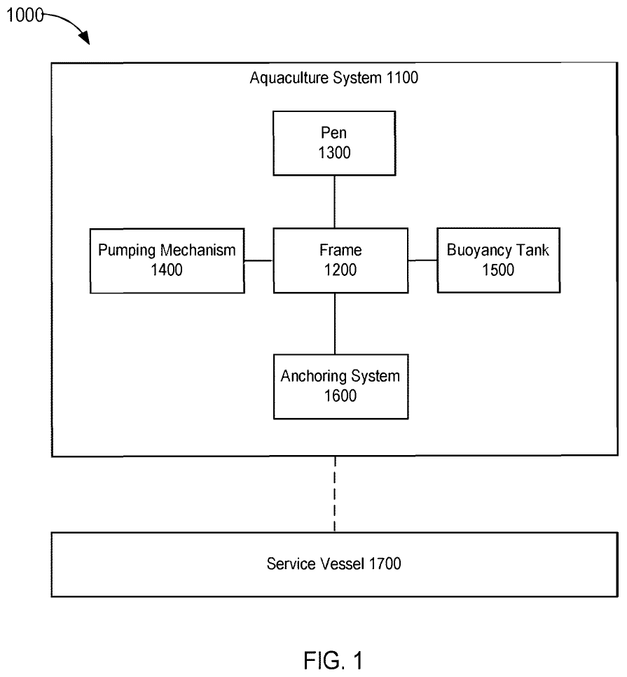

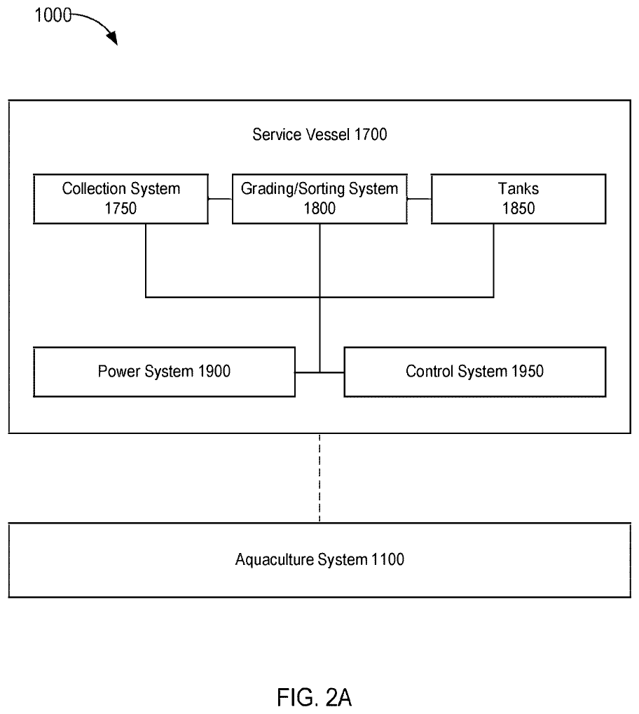

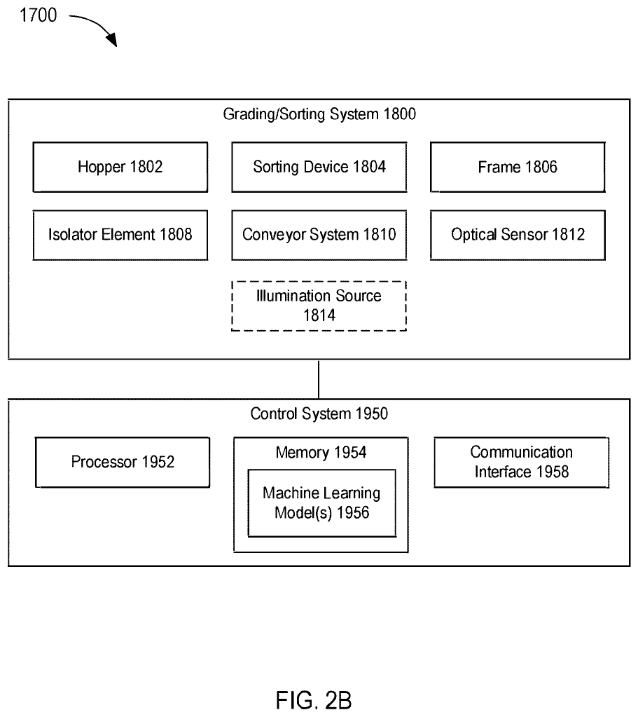

Referring now to the drawings, FIGS. 1-2B are schematic block diagrams of at least a portion of a cultivation system 1000 for the cultivation and/or harvesting of aquatic animals, according to an embodiment. The cultivation system 1000 can include an aquaculture system 1100 configured to grow and/or cultivate aquatic animals and a service vessel 1700 that allows accessing, inspecting, transferring, harvesting, identifying, and/or counting the aquatic animals contained in and/or retrieved from the aquaculture system 1100, as described in detail herein.

### Aquaculture System

The aquaculture system 1100 can be any suitable system configured to facilitate the development of aquatic animals from the phylum Mollusca (e.g., oysters, clams, mussels, scallops, bivalves, abalone, and/or the like). In some implementations, the aquaculture system 1100 and/or portions thereof can be similar to or substantially the same as any of the aquaculture systems described in U.S. Pat. No. 10,945,417, filed Jul. 24, 2019, entitled, “Systems and Methods for the Cultivation of Aquatic Animals,” the disclosure of which is incorporated herein by reference in its entirety.

The aquaculture system 1100 can be configured to incubate and/or cultivate the aquatic animals during development. The aquaculture system 1100 can include a frame 1200, at least one bin 1300, a pumping mechanism 1400, one or more buoyancy tanks 1500, and an anchoring system 1600. In some embodiments, the aquaculture system 1100 or a portion of the components thereof can form a submergible upweller and/or downweller system configured to allow water to filter through the at least one bin 1300 containing the aquatic animals (e.g., an oyster bed) and out through one or more outlets or other outflow point or points. In some embodiments, the submergible upweller and/or downweller system can be submerged (e.g., at least partially submerged) beneath the surface of the water in which it is disposed, and a flow of water can be urged (e.g., via the pumping mechanism 1400) through the at least one bin 1300 at a controlled rate. The aquaculture system 1100 can be operated, for example, in an upwelling configuration or in a downwelling configuration. In the upwelling configuration, water can flow up and into the at least one bin 1300, through a portion of the aquaculture system 1100, and to and/or through the pumping mechanism 1400 and in the downwelling configuration, water can flow into and through the pumping mechanism 1400, through a portion of the aquaculture system 1100 and the at least one bin 1300, and down and out of the bin 1300, as described in further detail herein.

The frame 1200 can be configured to provide structural support and to facilitate assembly of the aquaculture system 1100. The aquaculture system 1100 can include at least one bin 1300 removably coupled to the frame 1200 and configured to contain and protect the aquatic animals during development. A pumping mechanism 1400 can be coupled to the frame 1200 and used to generate a flow of water across the aquatic animals in the at least one bin 1300. At least one buoyancy tank 1500 can also be coupled to the frame 1200 and used to float the aquaculture system 1100 on and/or in a body of water. The anchoring system 1600 can be coupled to the aquaculture system 1100 (e.g., the frame 1200), to limit an amount of drift of the aquaculture system 1100 in the body of water and/or relative to the service vessel 1700, as further described herein.

The frame 1200 can be used to mechanically support various components in the aquaculture system 1100, such as the bin(s) 1300, the pumping mechanism 1400, and the buoyancy tank(s) 1500. The frame 1200 can also have sufficient mechanical strength to withstand tidal waves and ocean currents to increase the operational lifetime of the aquaculture system 1100. In some embodiments, the frame 1200 can be a rigid frame structure formed from any number of struts (e.g., rod-shaped elements). In other embodiments, the frame 1200 can be formed from any number of plates and or panels. The panels of the frame 1200 can define a three-dimensional shape with one or more interior volumes that can be used to house, support, and/or attach various components (e.g., the bin(s) 1300 or the pumping mechanism 1400). In this manner, the frame 1200 can be used to mechanically support and protect the components disposed in the interior volumes. For example, the frame 1200 can be an assembly of panels, rods, beams, tubes, etc. forming a support structure with a substantially rectangular shape with one or more partitions, dividers, flanges, and/or shelves dividing the interior space. Additional panels can be disposed along the internal and/or external surface(s) of the frame 1200 to increase structural rigidity and/or to support other components.

The panels can include one or more tabs, braces, and/or brackets disposed along the length of the panel, which can function as mounting points to couple other components internally (e.g., the bin(s) 1300) and/or externally (e.g., the buoyancy tank(s) 1500 and/or the anchoring system 1600) to the frame 1200. The tabs can also be used to couple two or more frames 1200 together. In this manner, the aquaculture system 1100 can be modular where any number of frames 1200 (or frame sections) can be coupled together with each frame 1200 (or frame section) configured to support a particular component in the aquaculture system 1100. For example, the frame 1200 can include a first frame structure or portion supporting the pumping mechanism 1400, which is coupled to a second frame structure or portion supporting the bin(s) 1300. If a larger storage capacity is desired, the frame 1200 can include a third frame structure or portion, a fourth frame structure or portion, a fifth frame structure or portion, etc. supporting any number of additional bins 1300.

The components and/or panels of the frame 1200 can be coupled together using various coupling mechanisms including, but not limited to screws, bolt fasteners, welding, brazing, adhesives, or any combination thereof. In some embodiments, a number of panels can be formed from a single component to simplify assembly. For example, a panel can be bent to form an L-shaped bracket rather than coupling two separate panels together. The panels can be formed from various metals, plastics, and composites including, but not limited to aluminum, steel, stainless steel, polyethylene, polyvinyl chloride, polycarbonates, poly(methyl methacrylate), fiberglass, carbon fiber, and/or the like. A coating can also be applied to improve the corrosion resistance of the frame 1200 to salt water and/or fresh water. The coating can be various materials including, but not limited to polyurethane, epoxies, polytetrafluoroethylene (Teflon), zinc oxide, copper, and/or the like.

The bin(s) 1300 can be used to contain and at least partially enclose the aquatic animals during development. The aquaculture system 1100 can include any suitable number of bins 1300. For example, in some embodiments, the aquaculture system 1100 can include a single bin 1300. In other embodiments, the aquaculture system 1100 can include, for example, two bins, three bins, four bins, five bins, six bins, seven bins, eight bins, nine bins, ten bins, fifteen bins, twenty bins, twenty five bins, thirty bins, or more (or any number therebetween). In some implementations, the bins 1300 in the aquaculture system 1100 can be similar and/or substantially the same. Accordingly, the discussion below with respect to a single bin 1300 is intended to refer to and/or is intended to apply to any of the bin(s) included in the aquaculture system 1100 unless expressed stated otherwise.

The bin 1300 can be formed from various metals, polymers, and/or composite materials including, but not limited to aluminum, steel, stainless steel, polyethylene, polyvinyl chloride, polycarbonates, poly(methyl methacrylate), fiberglass, carbon fiber, and/or the like. The exterior surface of the bin 1300 can be coated with an anti-fouling coating to reduce unwanted growth of aquatic organisms, which can potentially restrict the flow of water through the inlet over time. The anti-fouling coating can be formed from various coatings including, but not limited to, silicone, Teflon, graphite, and/or the like. The materials can be chosen to reduce environmental impact and to avoid contamination of developing aquatic animals in the aquaculture system 1100.

In some embodiments, the bin 1300 can be a substantially enclosed structure (e.g., a trough-like structure) with enclosed sidewalls, a closed bottom surface, and an open top surface. In some embodiments, the bin 1300 can be a number of containers, receptacles, canisters, bins, and/or the like with a closed top surface or lid. In some embodiments, the bin 1300 can have a substantially open bottom surface or a bottom surface that forms a grate or a number of openings. The bin 1300 can be dimensioned and shaped to fit substantially within the partitions or shelves of the frame 1200 described above. The bin 1300 can include any number of surfaces, tabs, or flanges configured to align with and/or correspond to the panels or shelves of the frame 1200 to allow the bin 1300 to be removably coupled to the frame 1200. The pen 1300 can thus be at least temporarily (e.g., removably) coupled to the frame 1200 via the tabs or flanges using various coupling mechanisms.

Aquatic animals, for example, from the phylum Mollusca, can be disposed on the bottom surface of the bin 1300 during development. To generate a flow of water across the aquatic animals, the bottom surface can include one or more inlets (not shown) where water is flowed into the bin 1300 from the surrounding body of water. The bin 1300 can also include one or more outlets (not shown) where water can flow out of the bin 1300. In some embodiments, the one or more inlets and/or the one or more outlets can be, for example, any number of openings, perforations, louvers, slots, and/or any other structure or defined void configured to allow flow therethrough. To generate a flow of water, the pumping mechanism 1400 can be coupled to the inlet or outlet of the bin 1300 and configured to generate a pressure difference such that water is continually flowed across the aquatic animals during operation from the inlet to the outlet, corresponding to an upwelling configuration of the aquaculture system 1100. The aquaculture system 1100 can also be operated in a downwelling configuration where the flow of water is reversed (e.g., water flows from the outlet to the inlet through the bin 1300). In some implementations, the downwelling configuration can be used to help younger aquatic animals attach to the bin 1300 during initial stages of development.

In some embodiments, each of the bins 1300 can be configured to receive and retain aquatic animals (e.g., mollusks) at a different stage of development. In some embodiments, larval aquatic animals can be contained within a first bin 1300 from the number of bins 1300. In some embodiments, larval aquatic animals can include trochophore larva and/or veliger. In some embodiments, juvenile aquatic animals can be contained within a second pen from the number of pens 1300. In some instances, juvenile aquatic animals can include oyster spat having a length of less than about 1 millimeter (mm), about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 21 mm, about 22 mm, about 23 mm, about 24 mm, about 25 mm, about 26 mm, about 27 mm, about 28 mm, about 29 mm, or about 30 mm, inclusive of all values and ranges therebetween. In other instances, juvenile aquatic animals can include oyster spat having a length that is less than about 1 mm or greater than about 30 mm.

In some the bin 1300 can include a growth material to which the larval or juvenile aquatic animals can attach during development. In some embodiments, the bin 1300 can include a growth material from which the larval or juvenile aquatic animals can form a cyst that substantially protects the aquatic animal during development. In some embodiments, the larval aquatic animal may develop a shell, for example a shell that consists of mainly chitin and conchiolin (a protein hardened with calcium carbonate). In some embodiments, operating the aquaculture system 1100 in the downwelling configuration may improve attachment of juvenile aquatic animals within the bin 1300. In some embodiments, as the aquatic animals develop through the subsequent stages of maturity, according to any suitable characterization or subdivision thereof, the aquatic animals from the first bin 1300 can be moved to the second bin 1300 and the aquatic animals from the second bin 1300 can be moved to a third bin 1300. In some embodiments, the bins 1300 can increase in size with the different stages of aquatic animal development. In some embodiments, the flow rate of water through the bins 1300 can increase with the stages of aquatic animal development. In some embodiments, the bins 1300 can be formed from a mesh (e.g., a wire mesh) having a maximum porosity that can increase with the stages of maturity of aquatic animal contained therein. In some embodiments, the largest porosity of the bins 1300 can be smaller than the lesser of a minimum length, a minimum width, or a minimum height of the aquatic animals contained therein.

In some embodiments, the bin 1300 can include any number of compartments (not shown) that subdivide the interior space of the bin 1300 into smaller portions of space where aquatic animals can be stored. The compartments can be shaped and dimensioned such that the flow of water within the compartment flows across the aquatic animals along a preferred direction. The compartments can also be used to compensate for possible variations in pressure within the larger interior space of the bin 1300, which can lead to undesirable water current flow. Each compartment can include one or more inlets on a surface (e.g., the bottom surface) of the bin 1300, where water is flowed into (or out of) the compartment and one or more side or top openings (not shown) where water is flowed out of (or into) the compartment. The one or more inlets and outlets can have dimensions smaller than the average size of aquatic animals to sufficiently contain the aquatic animals while providing a sufficient flow of water for nourishment. In some embodiments, the one or more inlets and outlets can be any number of openings, perforations, louvers, slots, and/or any other structure or defined void configured to allow flow therethrough.

As described above, in some embodiments, the bin 1300 can be disposed on and/or removably coupled to the frame 1200 in any suitable geometrical arrangement. For example, in some embodiments, the aquaculture system 1100 can include multiple bins 1300 and a channel. Each of the bins 1300 can be disposed inside a rectangularly-shaped portion of the frame assembly 1200 crossed by a number of flanges, dividers, panels, and/or partitions, which create a series of compartments, shelves, and/or frame structures. The spacing of the frame structures can be configured such that one bin 1300 can be disposed between two adjacent frame structures. Furthermore, two rectangularly-shaped frame assemblies or portions 1200 can be disposed in an aligned or adjacent arrangement (e.g., in a parallel configuration) and separated laterally by a distance that defines the width of the channel (e.g., between the aligned or adjacent bins 1300). In other words, the frame 1200 can includes any number of frame structures allowing, for example, for two rows of bins 1300 removably coupleable to the frame structures with a channel defined between the two rows of bins 1300. In some embodiments, the rectangularly-shaped frame assemblies can be coupled with braces, brackets, and/or spacers such that the width of the channel of the bin 1300 is determined by the dimensions of the braces, brackets, and/or spacers used to couple the rectangularly-shaped frame assemblies. In some implementations, the length of the channel is determined by the number of pairs of coupled rectangularly-shaped frame assemblies or portions that are disposed along a longitudinal axis of the aquaculture system 1100 forming two rows of frame assemblies. Said another way, in some implementations, the length of the channel can be determined by and/or at least partially based on the number of pairs of bins 1300 that are intended to removably couple to the frame 1200.

As described above, each bin 1300 can include one or more inlets on a surface (e.g., the bottom surface) of the bin 1300 to allow water to flow into (or out of) the bin 1300 and, for example, one or more side and/or top openings to allow water to flow out of (or into) the bin 1300. In some embodiments, the one or more openings (e.g., inlets and/or outlets) can be fluidically coupled to the channel of the aquaculture system 1100 formed by the frame 1200 (e.g., the rectangularly-shaped frame assemblies) to collect and/or redirect the flow of water eluted from the openings of the bin 1300. The channel can also be fluidically coupled to the pumping mechanism 1400 to generate a pressure difference such that water is continually flowed across the aquatic animals disposed in the bin 1300 during operation from the inlet, through the outlet, and through the channel corresponding to an upwelling configuration of the aquaculture system 1100. The aquaculture system 1100 can also be operated in a downwelling configuration where the flow of water is reversed (e.g., water flows from the channel, into and through the bin 1300, and into and/or through the inlet openings of the bin 1300). The downwelling configuration can be used to help younger aquatic animals attach to the bin 1300 during initial stages of development. Moreover, the arrangement of the channel is such that aquatic animals are not disposed therein. Rather, the channel provides a fluid flow path between the pumping mechanism 1400 and the bins 1300, as described in further detail herein.

In some embodiments, the bins 1300 can be configured to grow aquatic animals at different stages of development. For example, bins 1300 with a smaller size and/or with smaller compartments within the bin 1300 can be used for aquatic animals at earlier stages of development. However, as the aquatic animals grow larger, they can be moved into larger bins 1300 and/or bins 1300 with larger compartments. The one or more inlets in each bin 1300 can be dimensioned such that the water flow through the bin 1300 is based on the development stage of the aquatic animals. For example, the total area of the one or more inlets can be larger in bins 1300 configured for more mature aquatic animals to supply a higher water flow. Additionally, the flow rate of water can be varied between different bins 1300 based on the arrangement of the bins 1300 and/or the shape and dimensions of the channels between the bins 1300, which can affect the pressure drop between the inlet of the compartment and the outlet of the bin 1300.

In some embodiments, the bins 1300 can be removable from the frame 1200 to improve ease of harvesting, inspection, maintenance, and greater flexibility to configure the aquaculture system 1100. In some embodiments, the bin 1300 can be removable and configured to be disposed and/or transferred among various locations within the cultivation system 1000. For example, in some embodiments, the removable bins 1300 can include one or more hooks disposed on a portion of the top surface of the bin 1300 and configured to facilitate manual pick up of the removable bins 1300 by an operator. Alternatively, in some embodiments, the bins 1300 can include one or more hooks configured to be engaged and transported by a crane, a robotic arm, an actuator, and/or the like from one initial position in the cultivation system 1000 to another position within the cultivation system 1000 (e.g., into or onto the service vessel 1700). The hooks can be coupled to the body of the bin 1300 via mounting brackets and/or flanges. In some embodiments, the bin 1300 can include two or more hooks and a rod connecting them to facilitate lifting, transporting, the bins 1300 within the cultivation system 1000, as further described herein.

In some embodiments, the aquaculture system 1100 can include one or more buoyancy tanks 1500 for floatation. The buoyancy tank(s) 1500 can be, for example, sealed container(s) disposed along the periphery, sides, and/or ends of the aquaculture system 1100. The one or more buoyancy tanks 1500 can be dimensioned to have a total volume such that if the volume is substantially filled with air at standard or atmospheric temperature and pressure, the resultant buoyant forces applied to the one or more buoyancy tanks 1500 (e.g., by the water in which the aquaculture system 1100 is disposed) is greater than a force associated with the total weight of the aquaculture system 1100. In some embodiments, the buoyancy tank 1500 can be configured to float the aquaculture system 1100 in an environment with substantially pure water (e.g., generally referred to a “fresh water” and/or water with a density of approximately 1000 kg/m3). For saltwater environments, the density of salt water is higher than fresh water, thus, buoyant forces applied to the buoyancy tank 1500 will be greater than the buoyant forces of substantially pure water (e.g., fresh water) and/or brackish water (e.g., a mixture of fresh water and salt water). An additional safety margin can be incorporated into the design of the buoyancy tank 1500 to ensure buoyant forces are also sufficient to counteract external forces applied to the aquaculture system 1100 during operation (e.g., tidal forces, ocean currents, wind, tension from the anchoring system 1600, etc.). In some implementations, the buoyancy tank(s) 1500 can be at least partially filled with water or other fluid (e.g., other than air) to decrease an amount of buoyancy provided to the aquaculture system 1100.

The one or more buoyancy tanks 1500 can be disposed on and/or in the aquaculture system 1100 such that any resultant torque caused by the buoyant forces on a particular buoyancy tank 1500 is substantially cancelled or otherwise matched by a corresponding torque originating from an opposing buoyancy tank 1500. In this manner, the aquaculture system 1100 can remain in a preferred orientation during operation. For example, the preferred orientation of the aquaculture system 1100 can be to have the bin 1300 substantially horizontal such that the aquatic animals rest towards the bottom of the bin 1300. In some embodiments, a single buoyancy tank 1500 can be used where the tank is shaped and dimensioned to substantially surround at least a portion of the aquaculture system 1100. For example, the buoyancy tank 1500 can be a circular or ellipsoidal toroid, with the frame 1200, the pumping mechanism 1400, and the bin 1300 disposed within the central opening of the toroid. In some embodiments, one or more buoyancy tanks 1500 can be disposed along the periphery of the aquaculture system 1100. For example, the buoyancy tank 1500 can be a pair of tanks disposed on opposing sides of the aquaculture system 1100. The length of each buoyancy tank 1500 can be comparable to the total length of the one or more frames 1200 in the aquaculture system 1100. In another example, any number of spheroidal or ellipsoidal shaped buoyancy tanks 1500 can be disposed uniformly along the periphery of the aquaculture system 1100.

In some embodiments, the aquaculture system 1100 can include multiple buoyancy tanks 1500 with two or more buoyancy tanks 1500 coupled to one or more portions of the frame 1200 on the front of the aquaculture system 1100, and two or more buoyancy tanks 1500 coupled to the frame (or bin 1300) on the rear of the aquaculture system 1100. In some instances, the arrangement of the front and rear buoyancy tanks 1500 can be such that the front and rear buoyancy tanks 1500 are substantially parallel to and disposed on opposite sides of a longitudinal axis of the bin 1300 and/or the frame 1200, for example occupying and/or being disposed at or near the four corners of a rectangular-shaped aquaculture system 1100.

The use of multiple buoyancy tanks 1500 can provide an additional safety margin in the operation of the aquaculture system 1100. For example, if a buoyancy tank 1500 were to fail due to a leak or rupture, the remaining buoyancy tanks 1500 can still provide sufficient buoyancy to float the aquaculture system 1100 while maintaining a preferred orientation. In some embodiments, each buoyancy tank 1500 can also include multiple internal compartments that can be sealed from adjacent compartments. A leak or rupture in the buoyancy tank 1500 can be localized to a single or a few compartments, thus the integrity of the buoyancy tank 1500 is maintained.

The buoyancy tank 1500 can be coupled to the frame 1200 using various coupling mechanisms including, but not limited to, clamps, bolt fasteners, metal straps, ropes with buckles, welds, adhesives, and/or the like. For example, one or more straps can be tied around a portion of the buoyancy tank 1500 and the frame 1200. The one or more straps can be secured and tightened (e.g., by a buckle) such that sufficient frictional force is applied to constrain the buoyancy tank 1500 to the frame 1200. In another example, one or more ring clamps can be disposed around a portion of the buoyancy tank 1500 and tightened by a bolt fastener or a ratcheting mechanism. The ring clamp can include one or more tabs that can be coupled to the frame 1200 using various coupling mechanisms including, but not limited to bolt fasteners, welding, brazing, adhesives, and/or the like. As another example, the buoyancy tanks 1500 can be welded to, joined to, and/or otherwise integral with one or more portions of the frame 1200. For example, the buoyancy tanks 1500 can include a metal box or exterior structure that can be coupled to and/or integrally formed with one or more portions of the frame 1200. In some implementations, such a buoyancy tank 1500 can include, for example, an inner bladder or the like. In other implementations, such a buoyancy tank 1500 can be and/or can form a substantially sealed chamber with, for example, an inlet and/or outlet to allow fluid (e.g., a gas such as air, a liquid such as water, and/or the like) flow into and/or out of the buoyancy tank 1500 to adjust an amount of buoyancy of the tank 1500.

In some embodiments, the buoyancy tanks 1500 can be a rigid, thin-walled vessel whose shape and dimensions remain substantially unchanged when filled with air or water and can support pressurized fluids. In some embodiments, the buoyancy tank 1500 can be an inflatable tank with deformable walls configured to withstand pressures greater than one atmosphere (atm). Depending on the form factor, the buoyancy tank 1500 can be formed from various metals, polymers, composites, etc., including, but not limited to aluminum, steel, stainless steel, rubber, polyethylene, polyvinyl chloride, polycarbonates, poly(methyl methacrylate), fiberglass, carbon fiber, and/or the like. In some embodiments, the buoyancy tank 1500 can be sealed once filled with air either during manufacture or during deployment.

In some embodiments, the buoyancy tank 1500 can be used to control the depth of the aquaculture system 1100 within a body of water. For example, the buoyancy tank 1500 can be coupled to a pump (not shown), which can be configured to pump air, water, and/or any other suitable fluid in and out of the buoyancy tank 1500 via one or more valves disposed on the buoyancy tank 1500. In some embodiments, the aquaculture system 1100 can include a water pump (e.g., pumping mechanism 1400) configured to flow water into and/or out of the buoyancy tank 1500. In some embodiments, the aquaculture system 1100 can include a compressor or other pneumatic pumping device and a compressed air tank such that air from an external source or from the atmosphere (when the aquaculture system 1100 is not submerged) can be flowed into the compressed air tank for use later to displace water in the buoyancy tank 1500. In some embodiments, the pump, compressor, and/or the like can be disposed on board the aquaculture system 1100. In other embodiments, the pump, compressor, and/or the like can be disposed on board the service vessel 1700, and can be coupled to and/or in communication with a control system 1950 and powered by a power system 1900 of the service vessel 1700, as further described herein.

In some embodiments, water can be flowed into the buoyancy tank 1500 in order to reduce buoyancy and water can be flowed out of the buoyancy tank 1500 in order to increase buoyancy. In some embodiments, air can be flowed into the buoyancy tank 1500 to increase buoyancy and air can be flowed out of the buoyancy tank 1500 in order to reduce buoyancy. In some implementations, the aquaculture system 1100 can use only water to adjust the buoyancy of the buoyancy tanks 1500. In some implementations, the aquaculture system 1100 can use only air to adjust the buoyancy of the buoyancy tanks 1500. In some implementations, the aquaculture system 1100 can use a combination of a gas (e.g., air) and a liquid (e.g., water) to adjust the buoyancy of the buoyancy tanks 1500. For example, in some instances, water can be flowed into the buoyancy tank 1500 in order to reduce buoyancy and air can be flowed into the buoyancy tank 1500 in order to increase buoyancy. In some instances, water can be flowed out of the buoyancy tank 1500 by flowing air into the buoyancy tank 1500 to increase buoyancy. In some instances, air can be flowed out of the buoyancy tank 1500 by flowing water into the buoyancy tank 1500 to reduce buoyancy.

One or more valves can be disposed along the buoyancy tank 1500 such that fluid (e.g., air, water, etc.) can flow into or out of the buoyancy tank 1500 without affecting the stability of the aquaculture system 1100. For example, the one or more valves can allow a flow of fluid into or out of the buoyancy tank 1500 such that the aquaculture system 1100 remains substantially horizontal when raised or submerged in the water. In some embodiments, the buoyancy tanks 1500 can be coupled to a compressed gas container (not shown) via a valve disposed on or in the buoyancy tanks 1500 or disposed on the compressed gas container and/or otherwise included in the aquaculture system 1100 or the service vessel 1700. In some instances, the valve can be configured to allow a gas into the buoyancy tanks 1500 from the compressed gas container to displace water or any other liquid in the buoyancy tanks 1500. A second valve (not shown) can be disposed on or in the buoyancy tanks 1500 and configured to allow fluid (e.g., gas and/or liquid) to be released from the buoyancy tanks 1500. In some instances, the second valve can be configured to not allow water to return to the buoyancy tanks 1500, creating a partial vacuum within the buoyancy tanks 1500. In some instances, the second valve can allow water to return to the buoyancy tanks 1500 as gas is released. In some embodiments, the second valve can be a one-way valve that releases the gas out of the buoyancy tanks 1500 and the buoyancy tanks 1500 can further include a third valve that is configured to open to allow water into the buoyancy tanks 1500.

The depth of the aquaculture system 1100 can thus be dynamically controlled (e.g., by a control system of the aquaculture system 1100 and/or the service vessel 1700 and/or any other suitable device or system, or combination thereof) to adapt to different operating conditions. For example, the buoyancy tanks 1500 can be substantially filled with air to raise the bin(s) 1300 out of the water to dry the aquatic animals for harvesting or for inspection. The buoyancy tanks 1500 can be partially filled with water and air such that that the bin 1300 is substantially submerged or at least partially submerged below the water when growing the aquatic animals without affecting the water flow through the bin 1300. In storm conditions or other weather conditions that can damage the aquaculture system 1100 and/or harm the aquatic animals, the buoyancy tanks 1500 can be filled with additional water or emptied of gas such that the aquaculture system 1100 is submerged (e.g., fully submerged) below the surface of the water at a desired depth. The control system can be coupled to the pump and the buoyancy tanks 1500 to facilitate remote control of the depth of the aquaculture system 1100 by a human operator, control algorithm, artificial intelligence, and/or the like.

The pumping mechanism 1400 can be used to generate a flow of water through the aquaculture system 1100 in order to replenish (e.g., continuously, or substantially continuously) nutrient-rich water for the developing aquatic animals. Based on the dimensions and/or geometry of the bins 1300, the pumping mechanism 1400 can be configured to generate a pressure differential such that the flow rate of water in the bin 1300 results in improved growth rates for a majority of aquatic animals in the bin 1300. In some instances, a desired flow rate of water into and/or through one or more of the pens 1300 can be, for example, about 1 gallon per minute (gpm), about 2 gpm, about 3 gpm, about 4 gpm, about 5 gpm, about 6 gpm, about 7 gpm, about 8 gpm, about 9 gpm, about 10 gpm, about 11 gpm, about 12 gpm, about 13 gpm, about 14 gpm, about 15 gpm, about 16 gpm, about 17 gpm, about 18 gpm, about 19 gpm, about 20 gpm, about 21 gpm, about 22 gpm, about 23 gpm, about 24 gpm, about 25 gpm, about 26 gpm, about 27 gpm, about 28 gpm, about 29 gpm, and/or about 30 gpm, and/or any suitable fraction therebetween. For example, in some instances, it may be desirable to allow a flow of water into and/or through one or more of the bins 1300 at a flow rate of about 20 gpm. In still other instances, it may be desirable to have a flow rate that is less than 1 gpm or greater than 30 gpm.

The pumping mechanism 1400 can be various types of pumps including, but not limited to rotary pumps, reciprocating pumps, paddle wheel systems, and/or the like. The pumping mechanism 1400 can be operably coupled to a power system to receive electrical power to drive the pump. In some embodiments, the pumping mechanism 1400 can receive electrical power by a cable (not shown) operably coupled to the pumping mechanism 1400 at one end and the power system at another end. As described in further detail herein, in some implementations, the power system can be included in and/or a part of the service vessel 1700 and can be configured to transfer electrical power to the pumping mechanism 1400 via any suitable electrical connection (e.g., directly via a power cable, power rail, etc., and/or indirectly by charging an onboard energy storage device such as a battery).

In some embodiments, the pumping mechanism 1400 can be configured to transition between two or more operating states based on a flow of electric power and/or one or more control signals received from a controller (e.g., the control system 1950, as described in further detail herein). For example, in some embodiments, the pumping mechanism 1400 can have a first operating state or a first configuration in which the pumping mechanism 1400 generates a pressure differential that is operable to draw a flow of water into the bin 1300 through the one or more openings (e.g., inlets/outlets) thereof, through at least a portion of the bin 1300, out of the bin 1300 and into the channel, and through the channel toward the pumping mechanism 1400. In other words, the pumping mechanism 1400 can be configured to draw or pull a flow of water into and through the bin 1300 when in the first operating state and/or configuration. In some embodiments, the pumping mechanism 1400 can have a second operating state or second configuration in which the pumping mechanism 1400 generates a pressure differential that is operable to draw a flow of water into the pumping mechanism 1400, through at least a portion of the channel, into and through at least a portion of the bin 1300, and out of the bin 1300 via the one or more openings (e.g., inlets/outlets) thereof. In other words, the pumping mechanism 1400 can be configured to push or urge a flow of water into and through the bin 1300 when in the second operating state and/or configuration.

In some embodiments, the pumping mechanism 1400 can also have a third operating state and/or third configuration in which the pumping mechanism 1400 is in a substantially “powered off” configuration. In other words, the third operating state and/or third configuration can be associated with the pumping mechanism 1400 being turned off and/or otherwise not drawing or pushing water into the bin 1300. In some embodiments, a power system (e.g., the power system 1900 of the service vessel 1700) and/or any other suitable portion of the cultivation system 1000 can be configured to withhold a flow of electric power otherwise provided to the pumping mechanism 1400 to place the pumping mechanism in the third operating state and/or configuration. For example, in some embodiments, it may be desirable to place the pumping mechanism 1400 in the third operating state and/or configuration when a natural current of the body of water provides sufficient flow of water into and/or through the bin 1300.

The aquaculture system 1100 can include one or more anchoring systems 1600 to moor the aquaculture system 1100 such that the various components and systems are kept in close proximity to one another during operation. Additionally, the anchoring systems 1600 can be configured to connect multiple aquaculture systems 1100 (e.g., in series configuration) and facilitate access of the aquaculture system(s) 1100 via the service vessel 1700 for harvesting operations, as further discussed herein. In some embodiments, multiple anchoring systems 1600 can be coupled to the periphery of the aquaculture system 1100 (e.g., the frame 1200) to constrain the motion of the aquaculture systems 1100 in a stable manner. For example, an anchoring system 1600 can be disposed on and/or coupled to a front portion of the aquaculture system 1100, a rear portion of aquaculture system 1100, or a combination thereof to limit undesirable rotation, drift, and/or other movement of the aquaculture system 1100 during operation.

In some embodiments, the aquaculture system 1100 can be configured to operate near shore and the anchoring system 1600 can thus be a land-based feature used for mooring including, but not limited to a quay, a wharf, a jetty, a pier, and/or the like. In some embodiments, the anchoring system 1600 can include an anchor deployed to rest on the bottom of a body of water (e.g., a relatively shallow body of water). Any suitable form of anchor may be used, including Danforth, Fluke, spade, delta, claw, plow, helical, mushroom, and/or the like. In some embodiments, the anchor can be and/or can include an auger, block-based underwater mooring, weighted mooring, and/or any other suitable approach to provide an underwater mooring attachment point. The anchor can be directly tethered to one or more systems in the aquaculture system 1100 using a rope, a chain, a cable, or a combination thereof.

For implementations in deeper waters, the use of longer ropes or chain can lead to excessive drift between the one or more systems in the aquaculture system 1100. In some such embodiments, a mooring buoy can instead be coupled to the anchor, which can then serve as an anchoring point for the one or more systems in the aquaculture system 1100. In this manner, shorter ropes or chains can be used to anchor any number of the aquaculture systems 1100 to the mooring buoy, thus limiting the distance the systems can drift from each other. Although the buoy is not fixed in location, the aquaculture systems 1100 can collectively drift together in deep waters by securing the various aquaculture systems 1100 to the buoy. In some embodiments, the various systems in the aquaculture system 1100 can be directly coupled together using ropes or chains to limit drift between the various systems. A drogue can also be coupled to the buoy or the various systems in the aquaculture system 1100 to reduce the amount drift that occurs during operation. In some embodiments, the buoy can be a spar type buoy, the spar type buoy having a unique shape such that hydrostatic and hydrodynamic interactions of the buoy with the ocean or other waterway are decoupled enough so that extreme weather or ocean conditions do not induce extreme buoy motions. In some embodiments, at least one of the buoys coupled to the aquaculture system 1100 can be a spar type buoy.

In some embodiments, the anchoring system 1600 can include one or more linkages and mooring mounts configured to mechanically couple various aquaculture systems 1100 in a series configuration. For example, the anchoring system 1600 can include one or more linkages disposed on the front of an aquaculture system 1100 coupled to the frame 1200 and/or the buoyancy tanks 1500. The anchoring system 1600 can also include one or more mooring mounts disposed in the rear of the aquaculture system 1100 and coupled to the frame and/or buoyancy tanks. The linkages and mooring mounts can be coupled by various coupling mechanisms including, but not limited to, bolt fasteners, latches, buffer and chain couplers, pins, hooks, and/or radial couplers. In some embodiments, the anchoring system 1600 can include a pair of rails disposed on opposing sides of the aquaculture system 1100. The length of each rail can be comparable to the total length of the one or more frames 1200 in the aquaculture system 1100. The rails can be coupled to a set of casters, rollers, wheels and the like configured to facilitate moving the service vessel 1700 over the aquaculture system 1100, allowing transferring and harvesting operations, as further described herein.

### Service Vessel

FIG. 2A shows a schematic block diagram of the service vessel 1700 included in the cultivation system 1000. The service vessel 1700 can be configured to transfer, grade, and/or harvest aquatic animals cultivated in the aquaculture system 1100 (FIG. 1). The service vessel 1700 can be any suitable vessel configured to transfer, grade, sort, and/or harvest aquatic animals from the phylum Mollusca (e.g., oysters, clams, mussels, scallops, bivalves, abalone, and/or the like). In some implementations, the service vessel 1700 can be similar to or substantially the same as any of the service vessels described in International Patent Application No. PCT/US2021/35705, filed Jun. 3, 2021, entitled, “Systems and Methods for Transferring, Grading, and/or Harvesting Aquatic Animals,” the disclosure of which is incorporated herein by reference in its entirety.

The service vessel 1700 can be any suitable floatable vessel that can be operated in or on a body of water to selectively engage and/or interact with one or more aquaculture systems 1100 that are disposed in that body of water. For example, in some embodiments, the service vessel 1700 can be controlled (e.g., via human input or at least semi-autonomously) to place the service vessel 1700 near, adjacent, and/or parallel to one or more of the aquaculture systems 1100 allowing one or more systems of the service vessel 1700 to transfer aquatic animals therebetween (e.g., between the bins 1300 of the aquaculture system 1100 and the service vessel 1700). In some embodiments, the service vessel 1700 can be operatively coupled to the anchoring system 1600 to guide the movement of the service vessel 1700, facilitating alignment of one or more portions of the service vessel 1700 and the bins 1300 for transferring of aquatic animals therebetween, as further described herein.

The service vessel 1700 can include a collection system 1750, a grading/sorting system 1800, a set of tanks 1850, a power system 1900, and a control system 1950. The collection system 1750 can be configured to transfer aquatic animals between the service vessel 1700 and one or more enclosures or bins 1300 of the aquaculture system 1100. The grading/sorting system 1800 can be coupled to the collection system 1750 to receive aquatic animals collected by the collection system 1750 and to grade, sort, and/or sample the aquatic animals based on one or more predetermined characteristics. The grading/sorting system 1800 can also be coupled to the set of tanks 1850 configured to at least temporarily contain, and/or store sorted aquatic animals. In some implementations, the collection system 1750 can be further configured to collect from the set of tanks 1850 a portion of the aquatic animals disposed therein (such as those that do not have the predetermined characteristic(s) and/or that do not satisfy one or more predetermined criterion(ia)) and return them to the aquaculture system 1100. In some embodiments, the set of tanks 1850 can be a set of one or more holding tanks or the like configured to collect and/or at least temporarily hold the aquatic animals transferred to the service vessel 1700 from the aquaculture system 1100.

As described above, in some embodiments, the collection system 1750 can be configured to transfer aquatic animals between the service vessel 1700 and one or more enclosures or bins 1300 of the aquaculture system 1100. In some embodiments, the collection system can be a crane, a robotic arm, an actuator, and/or the like. More particularly, the collection system 1750 can include a base, an arm support, one or more actuators, and an end effector. The base can be a structure or compression element configured to carry loads and provide mechanical support to the stationary and/or moving components of the collection system 1750. In some embodiments, the base can be a pedestal, footing, or foundation disposed on the deck of the service vessel 1700. The base can be fabricated from different materials including structural wood, steel plates, natural stone, concrete, reinforce concrete, and the like.

The arm support can be an articulated spar or boom that can facilitate movement of various components of the collection system relative to a desired portion of the aquaculture system 1100. The arm support can be mechanically coupled to the base via screws, bolt fasteners, welding, brazing, adhesives, or any combination thereof. In some embodiments, the arm support can include any number of components, mechanical linkages, couplers, joints, and/or the like including one or more links connected by a kinematic, rotary, and/or motor-actuated joints, and/or the like. As such, the arm support can be configured to provide various ranges of rotational and/or translational motion (with any number of degrees of freedom) allowing other components of the collection system 1750 to be placed in any number of desirable positions. In some embodiments, the arm support can be configured to accommodate one or more actuators. In some embodiments, the arm support can be a bent boom. In some implementations, the arm support can be operated manually (e.g., via human input). In other implementations, the arm support device can be electronically, mechanically, pneumatically, and/or hydraulically controlled (e.g., in a programmable, semi-autonomous, and/or fully autonomous manner).

As described above, in some embodiments, the arm support can accommodate one or more actuators. The actuator can be any suitable mechanism that can be configured to execute and/or otherwise allow for a desired movement or positioning. As described above, the actuator can be coupled to the arm support using one or more tabs, brackets, mounts, flanges, and the like. In some embodiments, the actuator can be configured to produce linear movement and/or rotational movement. In some embodiments, the actuator can be mechanical, hydraulic, pneumatic, electromechanical, electrohydraulic, and/or magnetic. In some embodiments, the actuators can be controlled by the control system 1950. The one or more actuators can be coupled to an end effector. The end effector can be any suitable member configured to engage and/or couple, and/or handle one or more bins 1300. In some embodiments, the end effector can be an impactive end effector such as a jaw or claw configured to physically grasp, by direct contact, one or more portions of the bins 1300. In some embodiments, the end effector can be an ingressive end effector configured to fit, attach to, lock-in, and/or penetrate one or more surfaces of the bins 1300. In yet other embodiments, the end effector can be an astrictive end effector configured to impart suction forces and/or other attractive forces (e.g., magnetic forces) to and/or on one or more surfaces of the bins 1300. In some embodiments, the end effector can include one or more hooks and/or other suitable structures configured to matingly couple or connect to one or more portions of the bins 1300. For example, each bin 1300 can include a rod, rail, hook, handle, arm, etc. which can be hooked or otherwise engaged by the end effector (or hook included therein) of the arm support and/or actuator.

In some embodiments, the collection system 1750 can be coupled to the grading/sorting system 1800 to collect the aquatic animals that do not meet the predetermined characteristics and/or do not satisfy the predetermined criteria, and to return them to the aquaculture system 1100. For example, in some embodiments, the collection system 1750 can be coupled to and/or at least partially disposed in the set of tanks 1850 to transfer at least some of the aquatic animals contained in the tanks 1850 to the aquaculture system 1100, as further discuss herein. In some embodiments, the collection system can be coupled to a conveyor system included in the grading and/sorting system 1800 to directly transport at least a portion of the aquatic animals sorted in a sorting device to the aquaculture system 1100. In other implementations, the collection system 1750 can be used to transport aquatic animals to one or more other storage members, holders, conveyers, etc. of a harvesting system or the like (e.g., not necessarily included in the service vessel 1700). For example, the collection system 1750 can be used to offload the sorted and collected aquatic animals at a processing facility or the like.

The grading/sorting system 1800 can be configured to identify, grade, sort, sample, count, etc. aquatic animals. Generally, the grading/sorting system 1800 described herein can include a compute device, controller, and/or components thereof configured to execute an artificial intelligence (AI), machine learning, and/or computer vision environment to process image data, classify and/or identify aquatic animals depicted in the image data, and count the positively classified and/or identified aquatic animals. For example, the grading/sorting system 1800 can include a controller or compute device configured to execute the AI environment, which may be accessible from any number of external devices such as a mobile platform (e.g., accessible through a mobile application executed on a mobile computing device) as well as a web-based platform (e.g., accessible through a web browser on a laptop, desktop, and/or any other suitable computing device). In these embodiments, a user or operator may interact with the mobile and web-based platforms interchangeably. For example, in some implementations, the grading/sorting system 1800 can be configured to grade, sort, classify, identify, count, etc. the aquatic animals (e.g., mollusks) based on one or more specified or predetermined characteristic(s), criterion(ia), and/or the like. In other instances, the grading/sorting system 1800 can be configured to obtain one or more subsets of aquatic animals selected randomly, or according to specific criteria.

In some embodiments, as shown in FIG. 2B, the grading/sorting system 1800 can include a hopper 1802, a sorting device 1804, a frame 1806, an isolator element 1808, a conveyor system 1810, an optical sensor 1812 (e.g., scanner), and an optional illumination source 1814. In some embodiments, the hopper 1802 can be coupled to the collection system 1750 and configured to contain, store, aggregate, and/or otherwise transfer aquatic animals received from the collection system 1750. In some embodiments, the hopper 1802 can be configured to reduce an amount of water transferred into the hopper 1802 as the aquatic animals (e.g., mollusks) are transferred to the hopper 1802. The hopper 1802 can also be coupled to the sorting device 1804 and configured to transfer the aquatic animals contained in the hopper 1802 to the sorting device 1804 for sorting, grading, and/or sampling subsets of aquatic animals according to one or more predetermined characteristic, such as size, shape, and/or geometry. In other embodiments, the grading/sorting system 1800 need not include a hopper 1802. For example, the collection system 1750 can be configured to deliver the aquatic animals directly to the sorting device 1804 without the use of a hopper.

In some embodiments, the hopper 1802 can include a vibrating feed, a pneumatic feed, and/or the like. In some embodiments, the hopper 1802 can include a drum, an elevator, a storage tank, one or more inlets and/or outlets, and/or the like. The hopper 1802 can be made various materials including, but not limited to, stainless steel, aluminum, nickel-chromium alloy (Ni—Cr), and/or any other suitable metal or metal alloy material. The hopper 1802 can be coated with various coatings including, but not limited to polyamide, epoxy, polyurethane, neoprene, Rilsan, Nuflon, microbead coatings, and/or the like. In some implementations, transferring aquatic animals to the hopper 1802 can include transferring a flow or volume of water in addition to the aquatic animals. In such implementations, the shape and/or configuration of the hopper 1802 can be such that the aquatic animals pass through the hopper 1802 to the sorting device 1804 while excess water is extracted and/or released from the hopper 1802.

As described above, the sorting device 1804 can be coupled to the hopper 1802 to receive, sort, grade, and/or sample aquatic animals according to predetermined characteristics. The sorting device 1804, for example, can be a circle-throw vibrating sorter, a high frequency vibrating sorter, a gyratory sorter, a trommel screen sorter, a tumbler screener, and/or the like. In some embodiments, the sorting device 1804 can include, for example, one or more vibratory motor(s), and a set of screens, each of which having a different mesh, pore, and/or opening size and/or shape, configured to separate the aquatic animals (e.g., mollusks) into different groups according to the mollusks size, shape, weight, and/or the like. In some embodiments, the sorting device 1804 can include an oscillating resonant mechanism powered by a linear vibrating drive configured to control the vibration amplitude, frequency, etc., and/or to hold the mechanism in resonance (i.e., at a frequency close to its natural frequency). In some embodiments, the sorting device 1804 can be a rotating tumbler including a drum or the like with multiple hole sizes, mesh sizes, pore sizes, etc., and a drive motor (e.g., an adjustable speed motor) configured to separate and/or remove aquatic animals having a size smaller than the hole size(s) from the aquatic animals having a size larger than the hole size(s). In some embodiments, the sorting device 1804 can include any other suitable separator, sorter, grader, etc.

In some embodiments, the sorting device 1804 can include multiple separators, screens, sorters, etc. allowing the sorting device to separate and/or sort the aquatic animals into any number of groups (e.g., according to size, shape, weight, etc.). In some embodiments, the sorting device 1804 can be made of stainless steel, aluminum, Ni-Cr, and/or any other suitable metal or metal alloy material. In some embodiments, the sorting device 1804 can be powered manually, powered by electricity and/or an electric motor, and/or powered by an engine (e.g., an engine configured to combust and/or consume diesel fuel, gasoline, natural gas, biofuel, and/or the like. In some embodiments, the sorting device 1804 can be coupled to the control system 1950 configured to control and/or communicate with one or more portions of the service vessel 1700 and/or the aquaculture system 1100, as further described herein. In some embodiments, the control system 1950 can be configured to monitor and/or control one or more aspects, parameters, functions, and/or operations of the sorting device 1804 by executing and/or implementing user or operator provided input or instructions, an automated or semi-automated control algorithm, an artificial intelligence, machine learning, and/or adaptive algorithm or system, and/or the like.

The sorting device 1804 can include, for example, an outlet or the like that can allow sorted aquatic animals to exit the sorting device 1804. In some embodiments, the outlet can be and/or can include a manifold or the like that can direct the sorted aquatic animals to additional components of the grading/sorting system 1800 such as, for example, the conveyer system 1810. More particularly, the outlet and/or manifold can include multiple channels, tubes, chutes, tracks, ports, and/or structures, each of which receiving a sorted subset of the aquatic animals (e.g., based on size, shape, weight, etc.). In some embodiments, for example, the sorting device 1804 can be configured to sort aquatic animals into two, three, four, five, six, seven, eight, nine, ten or more sorted subsets of aquatic animals (e.g., mollusks) based on a desired and/or predetermined characteristic and/or criteria. In some such embodiments, the sorting device 1804 can include outlet(s) or an outlet manifold that can provide a corresponding number of structures configured to provide the separated or sorted aquatic animals to different conveyers of the conveyer system 1810 based on the desired and/or predetermined characteristic and/or criteria.

In some embodiments, the sorting device 1804 can be coupled to a frame 1806 (e.g., support structure) that can include one or more rigid, semi-rigid, and/or flexible structure(s) configured to provide mechanical support to the sorting device 1804 and/or the hopper 1802. The frame 1806 can have dimensions sufficient to at least partially fit and/or support the hopper 1802 and sorting device 1804. In some embodiments, at least a portion of the frame 1806 (e.g., support structure) can be configured to dampen the vibrations generated during operation of the sorting device 1804. For example, the frame 1806 can include a set of coils or springs to prevent the propagation of vibrations produced during operation. In some embodiments, the frame 1806 can be anchored or coupled to an isolator element 1808 configured to suppress the propagation of vibrations from the sorting device 1804 to other components of the grading/sorting system 1800 and/or the service vessel 1700 such as the optical sensor 1812.

The isolator element 1808 can be made of various materials that exhibit a natural vibration frequency different (e.g., above or below) the vibration frequency of the sorting device 1804. The isolator element 1808 can be made of various materials including, for example, concrete, felt, rubber, cork, highly viscous fluid(s), and/or the like. In some embodiments, the isolator element 1808 can include one or more metal coils, pneumatic cylinders, hydraulic cylinders, and/or the like. In some embodiments, the isolator element 1808 can be a thick mat (formed of any of the materials described herein) disposed underneath the frame 1806 to dampen the vibrations. In other embodiments, one or more isolator element 1808 can be coupled to the optical sensor(s) 1812 and configured to suppress vibrations from affecting the quality of the image data generated by the optical sensor 1812. In some embodiments, the grading/sorting system 1800 can include any number of isolator elements. For example, the isolator element 1808 can be a mat or other device disposed underneath the frame 1806 to dampen vibrations. In addition, the grading/sorting system 1800 can include additional isolator elements that can be, for example, coupled to each optical sensor 1812 and/or to a frame or structure supporting each optical sensor 1812.

In some embodiments, the isolator element 1808 can include a set of gas struts (e.g., one or more gas struts) configured to reduce the propagation of the vibrations generated by the sorting device. The gas struts can be any size and/or suitable size, shape, and/or form. The gas struts can include various types of struts such as a fixed height cylinder, a spindle, a cable cylinder, a staged cylinder, a non-rotating cylinder, and/or the like and/or combinations thereof. The struts can include various features such as, for example, telescoping mechanisms for extending stroke, adjustable push-in force knobs or wires, degressive response mechanisms, and/or the like. The struts can include one or more tabs disposed along the length of the strut, which can function as mounting points to couple the struts to the isolator element 1808. In some embodiments, a number of struts can be formed from a single component to simplify assembly.

The conveyor system 1810 can be coupled to the sorting device 1804 to transport and/or distribute the sorted aquatic animals. The conveyor system 1810 can be and/or can include one or more belt conveyors, chain conveyors, pneumatic conveyors, flexible conveyors, line shaft roller conveyor, screw or auger conveyors, and/or the like. In some embodiments, the conveyor system 1810 can be coupled to the sorting device 1804 to transport the sorted aquatic animals away from the sorting device 1804. For example, each conveyer can be coupled to and/or aligned with a different outlet or different structure of an outlet manifold of the sorting device 1804. In this manner, each conveyer can receive a sorted subset of the aquatic animals based on the predetermined characteristic and/or criteria (e.g., size, shape, weight, etc.). The conveyors are configured to convey the corresponding sorted subset of aquatic animals to one or more desired tanks from the set of tanks 1850. In some implementations, the conveyors can convey aquatic animals that do not meet predetermined characteristics to predetermined tanks 1850, which in turn, can be engaged by a portion of the collection system 1750 or any suitable return system to return of the aquatic animals that do not meet the predetermined characteristics to the bins 1300 of the aquaculture system 1100, for example, for further development. In other implementations, the conveyors can convey aquatic animals that do not meet predetermined characteristics to predetermined tanks 1850 for discarding or for uses other than for human consumption (e.g., dead, injured, and/or otherwise undesirable aquatic animals).

In some embodiments, the conveyors of a conveyor system 1810 are configured to convey the corresponding sorted subset of aquatic animals to or past one or more optical sensors 1812 (e.g., scanners) configured to image, record, scan, and/or count the number of aquatic animals sorted prior to conveying the aquatic animals to the set of tanks 1850 and/or back to the collection system 1750 for returning to the bins 1300 of the aquaculture system 1100. The optical sensor 1812 can include any suitable device, system, and/or mechanism configured to image, characterize, classify, and/or count the number of aquatic animals graded, sorted, and/or sampled. In some embodiments, one or more optical sensors 1812 can be coupled to one or more of the conveyor system 1810, each conveyor included in the conveyer system 1810, the sorting device(s) 1804, the frame 1806, the isolation element(s) 1808, and/or the tank(s) 1850. In some embodiments, one or more optical sensors 1812 can be coupled to each tank of the set of tanks 1850. In some embodiments, the conveyor system 1810 can include one or more spreaders (e.g., a spreader for each conveyer) configured to place the aquatic animals in a desired configuration. For example, in some embodiments, the spreaders can organize and/or spread the aquatic animals (e.g., consecutively in one or more lines) to facilitate counting with the optical counter scanners (e.g., light blocking optical counter scanners). While the scanners are described above as being coupled to the conveyer system and/or the set of tanks 1850, in some embodiments, the scanners can be coupled to and/or included in the sorting device to count the total number of aquatic animals sorted.

In some embodiments, an optical sensor 1812 may include one or more of a scanner, a camera, a photodetector, a photodiode, a charged coupled device (CCD) or complementary metal-oxide semiconductor (CMOS) optical sensor, an optical lens assembly, and/or the like. In some embodiments, a scanner can be, for example, one or more optical counter scanners such as, for example, light blocking counters, light scattering counters, direct imaging counters, and/or the like. In some embodiments, the optical counter scanner can include, for example, at least one high-speed camera configured to capture or record images from one or more viewing angles. In some embodiments, the control system 1950 (or other controller or compute device) can be configured to execute any suitable analysis software to provide high-speed counting with high accuracy.

In some embodiments, the optical sensor 1812 included in the service vessel 1700 is configured for use in a marine environment which can also be prone to vibrations. In some embodiments, the optical sensor 1812 may be coupled to an isolator element or damping mechanism (e.g., the isolator element 1808 described above), which can be configured to reduce vibrations (e.g., robust to vibrations of a vessel) to improve image quality (e.g., reduce image blur, maintain focus), as described above. The optical sensor 1812 may be configured to be moisture-resistant, salt-resistant, corrosion-resistant, and/or rated or otherwise configured for use in marine applications. In some embodiments, the optical sensor 1812 can include a specialized lens such as certain ruggedized lenses and/or the like. In such embodiments, the lens can be chosen and/or designed to be compatible with other factors, features, and/or considerations associated with capturing high quality image data in challenging environments such as, for example, resistance to vibrations, marine grade equipment, desired focal length to allow free operation of mechanical components, and/or the like.

In some embodiments, the optical sensor 1812 may be configured to pan (e.g., move side-to-side), tilt (e.g., move up and down), and/or zoom (e.g., change a focal length of a lens). In some embodiments, the optical sensor 1812 may further comprise a lens cleaning device (not shown) configured to clear obstructions such as fluid, salt, and/or other debris that may accumulate on an exterior of the optical sensor 1812. The lens cleaning device may comprise one or more of a wiper, sponge, fabric, hydrogel, fluid outlets (e.g., water and/or air jets), and/or the like. The lens cleaning device may be actuated by the operator and/or may be automated by the grading/sorting system 1800, the control system 1950, and/or any other system of the service vessel 1700. In some embodiments, the grading/sorting system 1800 may include additional sensors (not shown), as described in more detail herein. In some implementations, the control system 1950 (and/or any other control system, compute device, etc.) can be configured to receive image data from the optical sensor(s) 1812 and can execute any suitable process and/or instructions associated with analyzing and/or processing the image data, as described in further detail herein.

In some embodiments, the grading/sorting system 1800 may optionally include an illumination source configured to illuminate a set of aquatic animals for an optical sensor 1812 to facilitate one or more of identifying, classifying, counting, and/or sampling aquatic animals. The optional illumination source 1814 (e.g., light source) may include one or more of a light emitter and/or an optical waveguide configured to provide illumination to enhance an image data and/or the quality of one or more images captured or recorded by the optical sensor 1812. Non-limiting examples of a light emitter include incandescent, electric discharge (e.g., excimer lamp, fluorescent lamp, electrical gas-discharge lamp, plasma lamp, etc.), electroluminescence (e.g., light-emitting diodes, organic light-emitting diodes, laser, etc.), induction lighting, and fiber optic cable. The illumination source 1814 may be coupled to and/or in communication with any component of the grading/sorting system 1800, and may be controlled by the control system 1950 and/or any other suitable controller.

The set of tanks 1850 can be coupled to and/or aligned with the conveyor system and configured to receive, contain, and/or store at least some of the aquatic animals sorted by the grading/sorting system 1800. The set of tanks 1850 can be any suitable shape and/or size. In some embodiments, the tanks 1850 can be disposed in and/or formed by a hull of the service vessel 1700 or portion thereof. For example, in some embodiments, the service vessel 1700 can be a catamaran or a pontoon boat with two hulls or pontoons positioned on opposite sides of the service vessel 1700. In such embodiments, one or both of the hulls or pontoons can include and/or can form one or more of the tanks 1850.

The set of tanks 1850 can be dimensioned to contain a minimum amount of water and/or liquid solution to facilitate preserving the aquatic animals disposed therein. The set of tanks 1850 can include a water recirculation system (not shown) with one or more bio-filters, sand filters, and/or ultra-violet filters to purify, clean, and/or sterilize the water and preserve the aquatic animals. The set of tanks 1850 can also include a valve, inlet, or port (not shown) configured to allow a flow of liquid into or out of the tanks 1850 (e.g., to at least partially fill one or more tanks 1850 with water, collect samples of water for quality control purposes, and/or the like).

As described above, the cultivation system 1000 can include a power system 1900 configured to supply electrical power to various components in the cultivation system 1000 (e.g., various components of the service vehicle 1700 and/or the aquaculture system 1100). In some embodiments, the power system 1900 can be included in and/or mounted on or to a portion of the service vessel 1700. In other embodiments, the power system 1900 can be physically separate from the service vessel 1700. For example, in some embodiments, at least a portion of the power system 1900 can be included in or mounted to the aquaculture system 1100. In order to supply power, a cable, power rail, and/or the like (not shown) can be used to connect the power system 1900 to the aquaculture system 1100. The cable (or other power connection) can include multiple electrical lines to supply power independently to various components in the aquaculture system 1100. For example, the power system 1900 can be configured to supply power continuously to the pumping mechanism 1400 and periodically to pumps coupled to the one or more buoyancy tanks 1500. In some implementations, the power system 1900 can be a charging station, power generation unit, and/or the like configured to provide a flow of electric power to one or more energy storage devices (e.g., batteries) included in the aquaculture system 1100, which in turn, can power the pumping mechanism 1400, buoyancy tanks 1500, and/or any other portion of the aquaculture system 1100.

The power system 1900 can be various types of power generation systems including, but not limited to, solar panels, wind turbines, tidal generators, gas generators, and/or hybrid power systems based on combinations thereof. In some embodiments, the power system 1900 can be used to power any suitable portion of the service vessel 1700, aquaculture system 1100, and/or any suitable number of aquaculture systems 1000. The power system 1900 can be configured to independently control the power supplied to each aquaculture system 1100. For example, a particular aquaculture system 1100 can be shut down during inspection while the remaining aquaculture systems 1100 remain operational. In some embodiments, the power system 1900 can be included in and/or housed together with the control system 1950 in or on the service vessel 1700 (or other portion of the cultivation system 1000 such as, for example, a buoy such as the spar type buoy described above, and/or the like).

The control system 1950 can be used to and/or otherwise configured to monitor and/or control the service vessel 1700 and/or the aquaculture system 1100 (and/or portions thereof). In some embodiments, the control system 1950 can include at least a portion of the power system 1900 and/or any other suitable portion of the cultivation system 1000. In some embodiments, the control system 1950 and/or a portion of the control system 1950 can be mounted on the service vessel 1700. In other embodiments, the control system 1950 and/or a portion of the control system 1950 can be mounted to any suitable type of buoy and/or to any suitable portion of the cultivation system 1000. In some embodiments, the control system 1950 can be configured to monitor and/or control the service vessel 1700 and/or aquaculture system 1100 via a control algorithm, an artificial intelligence algorithm or system, and/or a human operator. For example, in some instances, a user, operator, and/or administrator of the cultivation system 1000 can provide an operational command to the control system 1950. In some implementations, the user, operator, and/or administrator can directly provide the operational command (e.g., the user is aboard the service vessel 1700 and provides the operational command to the control system 1950 via a user interface thereof). In other implementations, the user, operator, and/or administrator can provide the operational command from a remote location by sending a signal via a remote electronic device, a remote controller, a personal computer, a workstation, a mobile device, a tablet, a wearable electronic device, and/or any other suitable compute device. The signal can be indicative of the operational command to the control system 1950 and/or any other portion of the cultivation system 1000. In other instances, the control system 1950 can be configured to monitor and/or control the cultivation system 1000 without user or operator input or manipulation (e.g., via any suitable automation, artificial intelligence, machine learning, etc.).

The control system 1950 can include, for example, a controller, a compute device, an electronic device, and/or any other suitable electronic or electromechanical control system. For example, in some embodiments, the control system 1950 can include an electronic compute device configured to execute and/or perform one or more processes associated with controlling the cultivation system 1000. In some embodiments, the electronic compute device can be, for example, a computer or compute device or system such as a single board computer, a stackable computer system (e.g., a PC/104 stack), a personal computer (PC), a server device, a workstation, and/or the like. In some embodiments, the electronic device can include at least a memory, the processor, and a communication interface.

For example, as shown in FIG. 2B, the control system 1950 can include at least a processor 1952, a memory 1954, and a communication interface 1958. In some embodiments, the memory 1954 can be, for example, a random access memory (RAM), static RAM (SRAM), dynamic RAM (DRAM), a memory buffer, a hard drive, a read-only memory (ROM), an erasable programmable read-only memory (EPROM), an electrically erasable read-only memory (EEPROM), a flash memory, volatile memory, non-volatile memory, combinations thereof, and/or the like. In some embodiments, the memory 1954 may store instructions to cause the processor 1952 to execute modules, processes, and/or functions associated with the device, such as image processing, image display, data and/or signal transmission, data and/or signal reception, communication, and/or control of one or more components of the cultivation system 1000. In some embodiments, the memory 1952 may be configured to store any received data and/or data generated by the cultivation system 1000. In some embodiments, the memory 1954 may be configured to store data temporarily or permanently.

The processor 1952 can be any suitable processing device configured to run or execute a set of instructions or code and may include one or more data processors, image processors, graphics processing units (GPU), physics processing units, digital signal processors (DSP), analog signal processors, mixed-signal processors, machine learning processors, deep learning processors, finite state machines (FSM), compression processors (e.g., data compression to reduce data rate and/or memory requirements), encryption processors (e.g., for secure wireless data transfer), and/or central processing units (CPU). The processor 1952 may be, for example, a general purpose processor, Field Programmable Gate Array (FPGA), an Application Specific Integrated Circuit (ASIC), a processor board, and/or the like. The processor 1952 may be configured to run and/or execute application processes and/or other modules, processes and/or functions associated with the system. The underlying device technologies may be provided in a variety of component types (e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and the like. For example, in some embodiments, the processor 1952 may be configured to access or receive imaging data, machine learning model training data set, and/or sensor data from one or more of a grading/sorting system 1800, a storage medium (e.g., memory 1954, flash drive, memory card), and/or any other system/component of the service vessel 1700 and/or cultivation system 1000.

The communication interface 1958 can be, for example, a network interface card and/or the like that can include at least an Ethernet port, a wireless radio (e.g., a WiFi® radio, a Bluetooth® radio, etc.), a high frequency radio, a satellite communication interface, and/or the like. In some implementations, the communication interface 1958 (and/or any other suitable portion of the control system 1950) can include at least a high-bandwidth wireless networking system having any suitable components (e.g., a PC/104 stack, a wireless networking card and antenna, an acoustic modem card and transducer), other peripheral instrumentation, a portion of the power system 1900 (e.g., a main battery, a solar power system, etc.), and/or the like. For example, in implementations in which the cultivation system 1000 is deployed near shore, the communication interface 1958 and/or other portion of the control system 1950 can use and/or can include conventional antennas used for cellular (e.g., via any suitable cellular network or combination of cellular networks such as a 2G, 3G, 4G/LTE, 5G, and/or other network) or Wi-Fi receivers and transmitters. In implementations in which the cultivation system 1000 is deployed in remote environments (e.g., open ocean and/or deep-water environments), high frequency radio or satellite communication systems can be used.

In some embodiments, the communication interface 1958 (and/or any other suitable portion of the control system 1950) can include and/or can implement a global positioning system (GPS) device to enable an operator, a system administrator, a control algorithm, an artificial intelligence procedure or algorithm, and/or the like to track the location of the service vessel 1700 and/or the aquaculture system 1100 substantially in real-time. In some embodiments, the control system 1950 can receive data from the GPS device and can determine a position of the service vessel 1700 and/or the aquaculture system 1100 and/or can otherwise relay the data to the operator or control algorithm.

As such the processor 1952 can be configured to run or execute a set of instructions or code stored in the memory 1954 associated with controlling one or more portions of the cultivation system 1000 and/or communicating with one or more portion of the cultivation system 1000 and/or any suitable remote electronic device via the communication interface 1958, and/or the like. In addition, in some embodiments, the control system 1950 can include a user interface such as a display, one or more peripheral devices, and/or any other suitable user interface, thereby allowing a human operator to interact with the control system 1950.

In some embodiments, the control system 1950 can provide and/or can perform status checks on various systems of the service vessel 1700 and/or the aquaculture system 1100. For example, the status checks and/or various system checks can include but are not limited to checking the status and/or operating state of the service vessel 1700 such as the collection system 1750, the grading/sorting system 1800, the power system 1900, and/or any other suitable system thereof. The status checks and/or various system checks of the aquaculture system 1100 can include but are not limited to the depth of the aquaculture system 1100, an air pressure, fluid pressure, and/or fill volume in the buoyancy tank 1500, a pumping rate and/or operational state of the pumping mechanism 1400, environmental conditions (e.g., water nutrient levels, water temperature, water pH, water salinity, etc.), mollusk development characteristics, local weather conditions, and/or the like. In some instances, a human operator can provide an input or command to the control system 1950 indicative of an instruction to control one or more portions of the service vessel 1700 such as, for example, operating the collection system 1750 to engage and/or collect one or more bins 1300 from the aquaculture system 1100 or to provide aquatic animals in the one or more bins 1300 to the grading/sorting system 1800, operating the power system 1900 to provide a flow electric power to one or more portions of the service vessel 1700 and/or aquaculture system 1100, and/or the like. In some implementations, the instructions can control one or more portions of the aquaculture system 1100 such as, for example, adjusting the depth of the aquaculture system 1100 using the buoyancy tank 1500 or adjusting the water flow rate using the pumping mechanism 1400. The cable and/or other electric power connection used to supply power to the aquaculture system 1100 can also be used to transfer commands or sensory data between the control system 1950 and the aquaculture system 1100. In some embodiments, the control system 1950 can be housed together with the power system 1900 (e.g., in the service vessel 1700) to reduce the number of physical systems deployed in the service vessel 1700.

In some implementations, the processor 1952 can be configured to receive image data from the optical sensor 1812 and can execute any suitable process and/or instructions associated with analyzing and/or processing the image data. In some embodiments, the memory 1954 may be configured to store one or more machine learning models 1956 (or computer vision model), which can be executed by the processor 1952. In some implementations, the processor 1952 can execute instructions and/or processes associated with training the machine learning model 1956 to predict a set of characteristics associated with the set of aquatic animals with, for example, high recall.

For example, in some implementations, the processor 1952 can receive image data (or can retrieve image data from the memory 1954 or from the optical sensor(s) 1812) depicting a set of aquatic animals (e.g., after the aquatic animals have been graded and/or sorted by the grading/sorting system 1800). The processor 1952 can execute the machine learning model 1956 (e.g., the trained model) to accurately identify characteristics associated with the aquatic animals or a group or set thereof, which in turn, can allow for a proper identification of the aquatic animals. In addition, the processor 1952 can count a number of the properly identified aquatic animals, for example, as they are transferred along the grading/sorting system 1800 (e.g., one or more conveyors) and into the tanks 1850. In some embodiments, the machine learning model 1956 executed by the processor 1952 may comprise, may include, and/or may be based on one or more of a deep learning model, faster region-based convolutional neural network (Faster R-CNN), single shot detector (SSD), CenterNet model, and combinations thereof.

In some embodiments, methods of classifying and/or counting aquatic animals may be performed using the grading/sorting system 1800 described herein. For example, a method of classifying and/or counting aquatic animals may include receiving image data (e.g., a single image or a number of images or frames collectively forming a video) depicting a set of aquatic animals and generated by the optical sensor 1812. In some embodiments, the processor 1952 can execute the machine learning model 1956 to predict and/or determine a set of characteristics associated with the set of aquatic animals based on the image data and to classify and/or identify the set of aquatic animals based on the set of characteristics. In addition, the processor 1952 can execute any suitable process or algorithm to count at least a subset of the aquatic animals based on the classification/identification. In some implementations, the machine learning model 1956 can be trained for high recall, which in turn, can increase an accuracy associated with correctly identifying and counting the aquatic animals relative to some known machine learning and/or computer vision models. In this manner, a set of characteristics and/or a record of an evolving inventory of aquatic animals may be tracked over time (e.g., over the development or maturing of the aquatic animals). For example, a distribution of animal sizes (e.g., as animals grow) and/or an absolute quantity of animals may be monitored over time for inventory management.

While particular examples are described above, it should be appreciated that any of systems and devices described herein may be used in any of the methods described here. Moreover, while components are described as being arranged in a certain configurations, it should be understood that such arrangements are presented by way of example only. For example, while the machine learning model 1956 is described above as being executed by the processor 1952 of the control system 1950, in other embodiments, the processor 1952 of the control system 1950 can be configured to execute instructions and/or processes associated with controlling one or more portions of the cultivation system 1000 (as described), while a separate compute device having at least a processor and a memory is configured to receive the image data associated with the aquatic animals and execute the machine learning and/or computer vision models and/or methods described above.

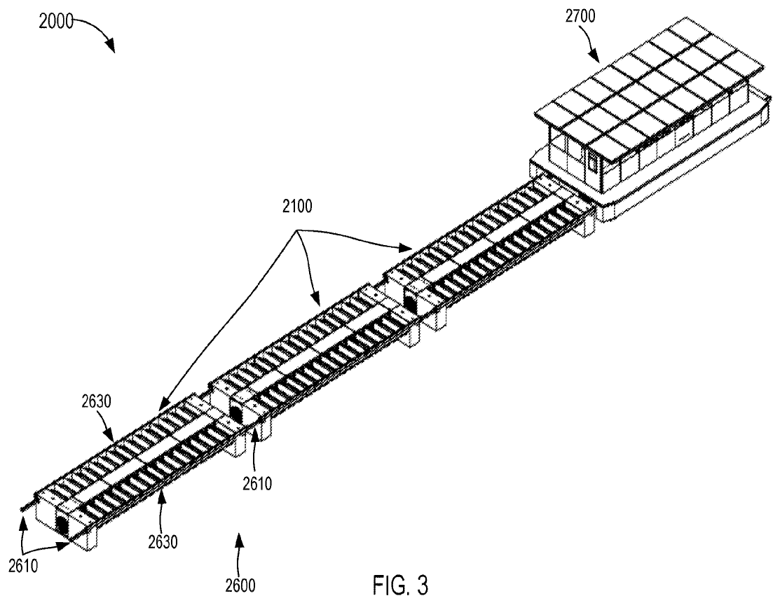

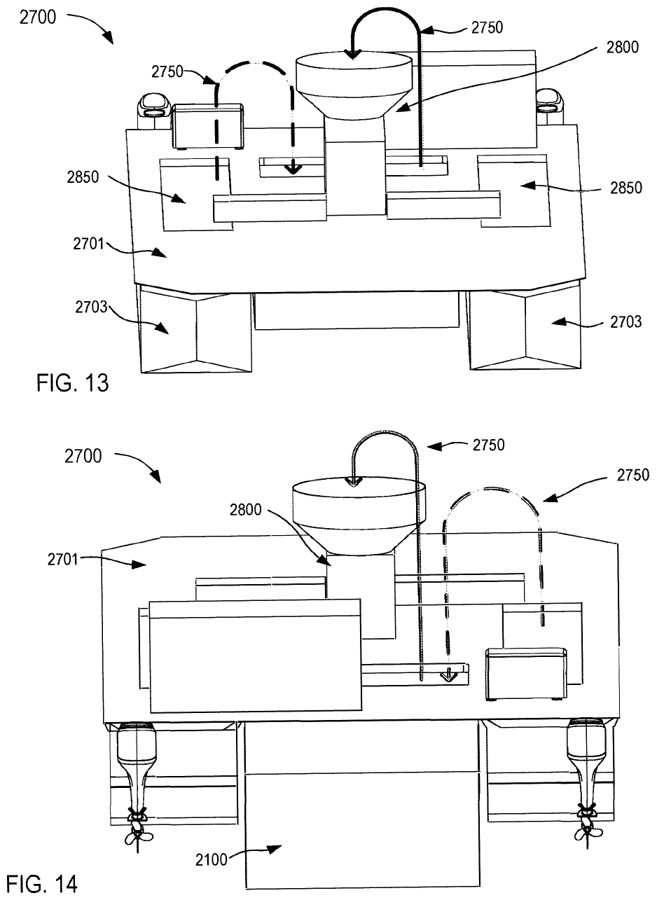

FIGS. 3-19 show various views and/or portions of a cultivation system 2000 for the cultivation and harvesting of aquatic animals, according to an embodiment. FIGS. 3-6 show the cultivation system 2000 including one or more aquaculture systems 2100 configured to grow aquatic animals, and a service vessel 2700 that allows accessing, inspecting, transferring, and/or harvesting the aquatic animals contained in the aquaculture systems 2100.

The cultivation system 2000 and/or each one of the aquaculture systems 2100 can include an anchoring system 2600 and/or interconnection system (referred to herein for simplicity as “anchoring system”). The anchoring system 2600 includes one or more linkages 2610 as well as one or more mooring mounts 2620 configured to mechanically couple any suitable number of aquaculture systems 2100 in a series configuration, as shown in FIGS. 3-5.

The linkage 2610 can be a wire, a chain bridle, a hawser, a notch tug or the like. The mooring mount 2620 can be a smit bracket, a tug, a chafe chain, or the like. In some implementations, a first aquaculture system 2100 can include one or more linkages 2610 disposed on the front of the first aquaculture system 2100. The linkage 2620 can be coupled to a buoyancy tank 2500 located on the front of the first aquaculture system 2100. The linkage 2610 of the first aquaculture system 2100 can also be removably coupled to a mooring mount disposed on a second aquaculture system 2100. The mooring mount 2620 can be disposed on the rear of the second aquaculture system 2100. In this manner, the first aquaculture system 2100 can be connected or linked to a second aquaculture system 2100 in a front to rear series arrangement, as shown in FIGS. 3-5. In some implementations, the connection or link established between the linkage 2610 and the mooring mount 2620 can form an electrical connection in addition to the mechanical connection. In this manner, any number of aquaculture systems 2100 can be mechanically and electrically connected or linked (e.g., in series) allowing for electric power and/or electric or electronic signals to be passed therebetween.

In some embodiments, the anchoring system 2600 can also include a pair of rails 2630 disposed on opposing sides of the aquaculture system 2100. The length of each rail can be comparable to the total length of the one or more frames 2200 in the aquaculture system 2100. The rails 2630 can be coupled to a set of casters 2710 (e.g., rollers, wheels, and/or the like) configured to facilitate moving the service vessel 2700 over the aquaculture system 2100, allowing transferring and harvesting operations. Although not shown, the anchoring system 2600 can further include an anchor, mooring buoy, and/or any other suitable device or member configured to at least partially anchor or otherwise limit movement, drift, and/or separation of one or more aquaculture systems 2100 relative to one another or relative to the service vessel 2700.

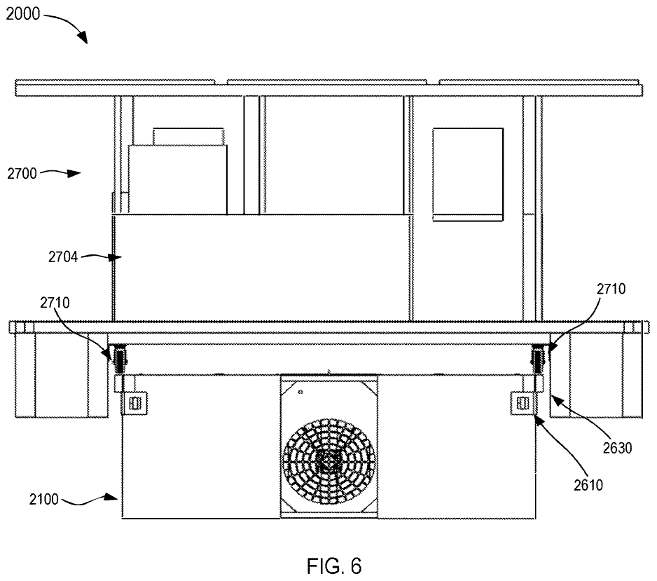

The aquaculture system 2100 (and/or the frame 2200 or the anchoring system 2600 thereof) can also include a pair of rub rails 2630 disposed on opposite sides of the aquaculture system 2100. The length of each rub rail 2630 is be comparable to and/or associated with the total length of the aquaculture system 2100, as shown in FIG. 3. The rub rails 2630 can be coupled to a set of casters 2710 in the service vessel 2700 (FIG. 6), such that collectively, the rub rails 2630 and the casters 2710 facilitate moving the service vessel 2700 over the aquaculture systems 2100 to transfer aquatic animals between the aquaculture system 2100 and the service vessel 2700, as further described herein. In some implementations, the rub rails 2630 can facilitate movement of the service vessel 2700 over the aquaculture system 2100 (as described) and can form and/or include at least a portion of an interface for transferring electric power between the service vessel 2700 and the aquaculture system 2100. For example, in some implementations, the rub rails 2630 can form and/or can include a power rail or the like having one or more conductors and the casters 2710 of the service vessel 2700 can similarly include one or more conductors such that an electrical connection is established therebetween. Moreover, at least a portion of the electric power received by one aquaculture system 2100 (e.g., via the connection between the rub rails 2630 and the casters 2710 or via any other suitable connection) can be passed and/or transferred to one or more other aquaculture systems 2100 connected to that aquaculture system 2100 (e.g., via the connection between the linkage 2610 and the mooring mounts 2620, and/or any other suitable connection).

### Aquaculture System

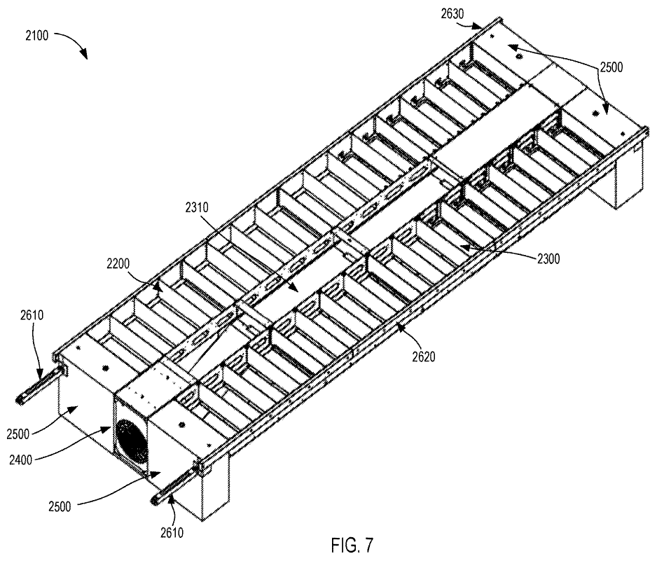

FIGS. 7-11C show the aquaculture system 2100 of the cultivation system 2000 in further detail. As described above, the aquaculture system 2100 is configured to cultivate, incubate, and/or otherwise protect aquatic animals (e.g., animals of the phylum Mollusca) during development. The aquaculture system 2100 can include a frame 2200, any suitable number of bins 2300, a pumping mechanism 2400, and one or more buoyancy tanks 2500. In some embodiments, one or more portions of the aquaculture system 2100 can be similar to or substantially the same as one or more corresponding portions of the aquaculture system 1100 described above with reference to FIGS. 1-2B. Accordingly, such portions may not be described in further detail herein.

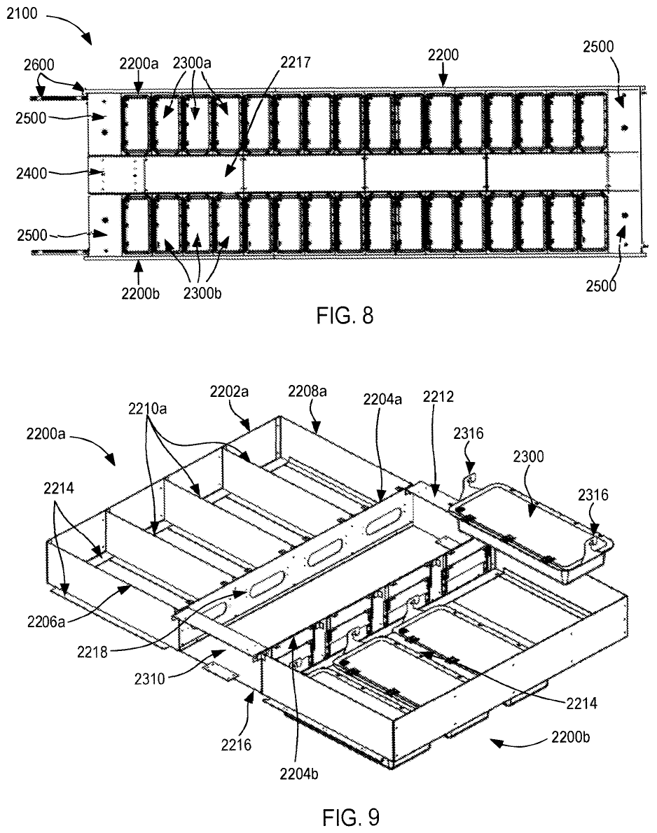

FIGS. 7 and 8 are a perspective view and a top view, respectively, of the aquaculture system 2100. The aquaculture system 2100 can be any suitable system or combination of systems configured to cultivate aquatic animals. In this embodiment, multiple frame assemblies 2200 can be used to facilitate assembly of the aquaculture system 2100. For example, as shown in FIGS. 8 and 9, a frame assembly 2200a can be configured to support the bins 2300a. A frame assembly 2200b supporting the bins 2300b can be coupled to the frame assembly 2300a and/or otherwise disposed across from the frame assembly 2300a. A third frame (not shown) can be configured to support the pumping mechanism 2400 and can be coupled to the frame assemblies 2200a and 2200b. In this manner, the assembly of the aquaculture system 2100 can be modular where additional bins 2300 can be added to the aquaculture system 2100 as desired.

The frame 2200 can be used to mechanically support various components in the aquaculture system 2100, such as the bins 2300, the pumping mechanism 2400, and the buoyancy tanks 2500. In some embodiments, the frame 2200 can also mechanically support and/or can otherwise form a channel 2310 that extends along a length of the aquaculture system 2100 and this is configured to be in fluid communication with the bins 2300, as described in further detail herein. The frame 2200 can also have sufficient mechanical strength to withstand tidal waves and ocean currents to increase the operational lifetime of the aquaculture system 2100. In some embodiments, the frame 2200 can be a rigid frame structure formed from any suitable number of plates and panels. The panels of the frame 2200 can define a three-dimensional shape with one or more interior volumes that can be used to house, support, and/or attach various components (e.g., the bins 2300, the channel 2310, and/or the pumping mechanism 2400). In this manner, the frame 2200 can be used to mechanically support and protect the components disposed in the interior volumes. For example, the frame 2200 can be an assembly of panels forming a substantially rectangular shape (e.g., a frame assembly) with one or more partitions, dividers, flanges, and/or shelves dividing the interior space. Additional panels can be disposed along the external surface of the rectangular box to increase structural rigidity and/or to support other components.

The panels can include one or more tabs, braces, and/or brackets disposed along the length of the panel, which can function as a mounting point to couple other components internally (e.g., the bins 2300) and/or externally (e.g., the buoyancy tanks 2500, and/or the anchoring system 2600) to the frame 2200. The tabs can also be used to couple two or more frames 2200 together. In this manner, the aquaculture system 2100 can be modular where any number of frames 2200 and/or frame sections or portions can be coupled together with each frame 2200 and/or frame section or portion configured to support a particular component in the aquaculture system 2100. For example, the aquaculture system 2100 can include a first frame section 2200 supporting the pumping mechanism 2400 coupled to a second frame section 2200 supporting the bins 2300. If a larger storage capacity is desired, a third frame section 2200 supporting another bin 2300 can be coupled to the aquaculture system 2100, and so on.

The panels can be coupled together using various coupling mechanisms including, but not limited to screws, bolt fasteners, welding, brazing, adhesives, or any combination thereof. In some embodiments, a number of panels can be formed from a single component to simplify assembly. For example, a panel can be bent to form an L-shaped bracket rather than coupling two separate panels together. The panels can be formed from various metals, plastics, and composites including, but not limited to aluminum, steel, stainless steel, polyethylene, polyvinyl chloride, polycarbonates, poly(methyl methacrylate), fiberglass, carbon fiber, and/or the like. A coating can also be applied to improve the corrosion resistance of the frame 2200 to salt water and/or fresh water. The coating can be various materials including, but not limited to polyurethane, epoxies, polytetrafluoroethylene (Teflon), zinc oxide, copper, and/or the like.

FIG. 9 shows details of a geometrical arrangement of the frame 2200 and the bins 2300. The frame 2200 includes a frame assembly 2200a or section configured to support a first set of the bins 2300 and a frame assembly 220b or section configured to support a second set of the bins 2300. The frame assembly 2200a comprises an exterior panel or wall 2202a, and an interior panel or wall 2204a coupled to a front divider 2206a and a rear divider 2208a. The front divider 2206a and the rear divider 2208a can be coupled to the exterior walls 2202a and to the interior wall 2204a with screws, bolts and or other suitable couplings. The frame assembly 2200a can also include a number of interior dividers 2210a configured to divide the interior space of the frame assembly 2200a into interior compartments or volumes. The dividers 2210a can be coupled to the frame assembly 2200a such that the interior volume generated between two adjacent dividers 2210a accommodates one bin 2300. The frame assembly 2200b or section can be, for example, in a mirrored arrangement relative to the frame assembly 2200a and thus, can similarly divide an interior space of the frame assembly 2200b into interior compartments or volumes that each accommodate one bin 2300 (the dividers of the frame assembly 2200b are not shown to allow visualization of various components of the frame assembly 2200b.

The bin 2300 can be disposed on the frame assembly 2200 by coupling an external surface of the bin 2300 to one or more mounting flanges 2214 located on the bottom of the frame assembly 2200a and/or the frame assembly 2200b. In that way, the frame assemblies 2200a and 2200b can accommodate multiple bins 2300. Furthermore, the frame assembly 2200a can be coupled to a frame assembly 2200b using one or more braces or brackets 2212. The interior wall 2204a of the frame assembly 2200a and the interior wall 2204b of the frame assembly 2200b can be coupled to a panel 2216 (e.g., a lower or bottom panel) to at least partially define the channel 2310 extending along a length of the frame 2200. The frame 2200 can further include a panel 2217 (e.g., an upper or top panel, as shown in FIG. 8) such that the channel 2310 is substantially enclosed on four sides with, for example, open ends.

The arrangement of the frame 2200 is such that the frame assemblies 2200a and 2200b receive and/or support a number of bins 2300 in two rows with the channel 2310 disposed therebetween, as shown in FIGS. 8 and 9. Moreover, the panels 2204a and 2204b define a number of openings 2218 along the sides of the channel 2310, with each opening placing an interior compartment or volume of the frame assemblies 2200a and 2200b (e.g., at least partially defined by the interior dividers 2210a and the corresponding interior dividers of the frame assembly 2200b, not shown) in fluid communication with the channel 2310. Each interior compartment or volume is configured to receive a bin 2300 such that each opening 2318 places a separate bin 2300 in fluid communication with the channel 2310 when the bin 2300 is disposed in the interior compartment or volume, as described in further detail herein.

The bins 2300 can be used to contain and enclose the aquatic animals during development. The bin 2300 can be formed from various metals, polymers, and/or composite materials including, but not limited to aluminum, steel, stainless steel, polyethylene, polyvinyl chloride, polycarbonates, poly(methyl methacrylate), fiberglass, carbon fiber, and/or the like. The exterior surface of the bin 2300 can be coated with an anti-fouling coating to reduce unwanted growth of aquatic organisms, which can potentially restrict the flow of water through the inlet over time. The anti-fouling coating can be formed from various coatings including, but not limited to, silicone, Teflon, graphite, and/or the like. The materials can be chosen to reduce environmental impact and to avoid contamination of developing aquatic animals in the aquaculture system 2100.

In some embodiments, each bin 2300 can be a substantially enclosed structure (e.g., a trough-like structure) with enclosed sidewalls, a closed bottom surface, and an open top surface. In other embodiments, each bin 2300 can be a container, receptacle, canister, and/or the like with a close top surface or lid. The bins 2300 can be dimensioned and shaped to fit substantially within the partitions or shelves of the frame 2200 described above. The bins 2300 can include any number of surfaces, tabs or flanges configured to align to the panels or shelves of the frame 2200. The bins 2300 can thus be coupled to the frame 2200 via the tabs or flanges, which in some implementations, can allow the bins 2300 to be removable from the frame 2200 (e.g., by one or more components or systems of the service vessel 2700).

In some embodiments, the bins 2300 can include one or more openings (e.g., inlets) located on the bottom surface of the bins 2300 (not shown), where water is flowed into the bins 2300 and one or more side and/or top openings (e.g., outlets) (not shown) where water is flowed out of the bins 2300. In some embodiments, the one or more side and/or top openings or outlets can be fluidically coupled to the channel 2310 via the openings 2218 in the panels 2204a and 2204b formed by the frame assemblies 2200a and 220b to collect and/or direct a flow of water eluted from the bins 2300. The channel 2310 is also fluidically coupled to the pumping mechanism 2400 to generate a pressure difference such that water can flow through the channel 2310 in both directions along a length of the channel 2310. For example, in some instances, water is flowed into the openings (e.g., inlets) of the bins 2300, through an interior of the bins 2300 and across the aquatic animals disposed therein, through the openings (e.g., outlets) of the bins 2300, into the channel 2310 via the openings 2318, and through the channel 2310 toward the pumping mechanism 2400, corresponding to an upwelling configuration. The aquaculture system 2100 can also be operated in a downwelling configuration where the flow of water is reversed. For example, water can be flowed into and through the channel 2310 via the pumping mechanism 2400, through the openings 2318 and into the bins 2300 via the openings (e.g., outlets) of the bins 2300, through the interior of the bins 2300 and across the aquatic animals disposed therein, and out the openings (e.g., inlets) of the bin 2300. The downwelling configuration can be used, for example, to help younger aquatic animals attach to the bins 2300 during initial stages of development.

In some embodiments, the bins 2300 can include compartments configured to grow aquatic animals at different stages of development. For example, bins 2300 with smaller compartments can be used for aquatic animals at earlier stages of development. However, as the aquatic animals grow larger, they can be moved into bins 2300 with larger compartments. The one or more inlet openings (e.g., on a bottom of the bins 2300 can be dimensioned such that the water flow is optimized for the developmental stage of the aquatic animals. For example, the total area of the one or more inlet openings can be larger in bins 2300 configured for more mature aquatic animals to supply a higher water flow than bins 2300 configured for younger aquatic animals. In some embodiments, the compartments can be removable from the bins 2300 to improve ease of harvesting, inspection, maintenance, and greater flexibility to configure the aquaculture system 2100

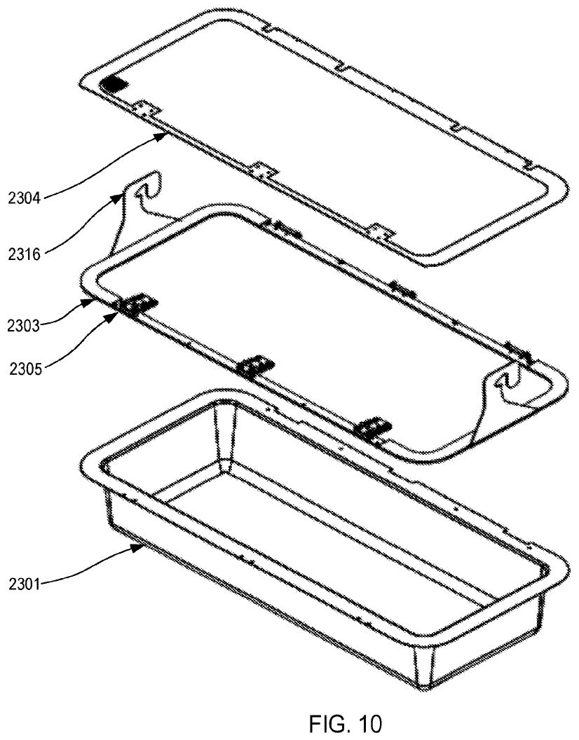

In some embodiments, the bins 2300 are removable from the frame 2200 and configured to be disposed and/or transferred between the aquaculture system 2100 and the service vessel 2700. For example, the removable bins 2300 can include one or more handles and/or hooks 2316 mechanically coupled to the removable bins 2300 and disposed on a portion of the top surface of the removable bins 2300 to facilitate lifting and transporting of the removable bins 2300, as shown in FIGS. 9 and 10. In some embodiments, the bins 2300 with hooks 2316 can be lifted, transported, and/or transferred via a crane, a robotic arm, and/or an actuator or the like from one initial position in the aquaculture system 2100 to another position within the service vessel 2700, as further described herein.

FIG. 10 is an exploded view of one of the removable bins 2300. The removable bin 2300 can include a shell 2301, a frame or engagement structure 2303, a lid 2304, and one or more hinges 2305. The shell 2301 can be a partially enclosed structure with enclosed sidewalls, a closed bottom, and an open top surface. The shell 2301 can include one or more openings (e.g., inlets/outlets) located on the bottom surface of the shell 2301 (not shown), such that water can flow into or out of the bins 2300. The top surface of the shell 2301 can be placed in contact with one or more flanges of the frame 2200 with a portion of the shell 2301 extending through an opening defined between the frame 2200 thereby temporarily and/or removably coupling the bin 2300 to the frame 2200. The top surface of the shell 2301 can be mechanically coupled to the frame or engagement structure 2303 using screws, bolt fasteners, welding, brazing, adhesives, or any combination thereof. The frame or engagement structure 2303 of the bins 2300 can include the one or more hooks 2316 configured to be engaged, and/or lifted by a crane, a robotic arm, and/or an actuator. The frame or engagement structure 2303 can also be coupled to the lid 2304 via one or more hinges 2305 mounted on the frame or engagement structure 2303. The lid 2304 can be movable between an open state and a closed state to allow access to the aquatic animals stored inside the removable bin 2300 or to at least temporarily enclose the aquatic animals stored inside the removable bin 2300.

In some embodiments, the shell 2301 can include one or more openings (e.g., inlets/outlets) located on the side of the shell 2301 or on the lid 2304 and configured to allow a flow of water between the bins 2300 and, for example, the channel 2310 via the openings 2318. As described above, the removable bin 2300 can be removably coupled to the frame assembly 2200 (e.g., via the contact between the shell 2301 and the flange(s) of the frame assembly 2200a. During operation, the bin 2300 can be lifted and/or otherwise removed from the frame 2200 manually by a human operator or via an automated, semi-automated, or manually controlled crane, robotic arm, and/or actuator by engaging the hook(s) 2316 of the bins 2300. Although not shown, in some embodiments, the frame or engagement structure 2303 can include a rod, rail, handle, and/or structure extending, for example, between the hooks 2316 allowing the bins 2300 to be engaged by a human operator, and/or a mechanical or robotic arm operated by a human or operated at least semi-autonomously. In some such embodiments, the hook(s) 2316 can be configured to engage a portion of the frame 2200 to allow the shell 2301 to be suspended from a portion of the frame 2200. In some embodiments, the lid 2304 can be temporarily maintained in the closed state by gravity and can be opened by gravity or a manually exerted force to facilitate extraction of the aquatic animals (e.g., by tipping the bin 2300 upside down or the like). In other embodiments, the lid 2316 can include a magnetic and/or an electric closing mechanism, a lock, a latch, a motor (e.g., a servo motor), and/or the like that can be activated, unlocked, and/or disengaged on board the service vessel 2700, as further described herein.

The pumping mechanism 2400 of the aquaculture system 2100 (see e.g., FIG. 7) can be various types of pumps including, but not limited to rotary pumps, reciprocating pumps, paddle wheel systems, and/or the like. As described above, the pumping mechanism 2400 can be used to generate a flow of water through the aquaculture system 2100 in order to replenish (e.g., continuously or substantially continuously) nutrient-rich water for the developing aquatic animals. Based on the dimensions and/or geometry of the bins 2300, the pumping mechanism 2400 can be configured to generate a pressure differential such that the flow rate of water in the bin 2300 results in improved growth rates for a majority of aquatic animals in the bin 2300. In some instances, a desired flow rate of water into and/or through one or more of the bins 2300 can be, for example, between about 1 gpm and about 30 gpm, as described above with reference to the pumping mechanism 1400. The pumping mechanism 2400 can be operably coupled to a power system 2900 to receive electrical power to drive the pump. In some embodiments, the pumping mechanism 2400 can receive electrical power by a cable (not shown) operably coupled to the pumping mechanism 2400 at one end and the power system 2900 at another end. In some embodiments, the power system 2900 can be included in the service vessel 2700 and the pumping mechanism 2400 can be electrically connected thereto.

In some embodiments, the pumping mechanism 2400 can be configured to transition between two or more operating states based on a flow of electric power and/or one or more control signals received from a controller. For example, in some embodiments, the pumping mechanism 2400 can have a first operating state or a first configuration in which the pumping mechanism 2400 generates a pressure differential that is operable to draw a flow of water into the bins 2300 through the one or more openings (e.g., inlets/outlets) thereof, through at least a portion of the bins 2300, out of the bins 2300 and into the channel 2310, and through the channel toward the pumping mechanism 2400. In other words, the pumping mechanism 2400 can be configured to draw or pull a flow of water into and through the bin 2300 when in the first operating state and/or configuration (e.g., the upwelling configuration). In some embodiments, the pumping mechanism 2400 can have a second operating state or second configuration in which the pumping mechanism 2400 generates a pressure differential that is operable to draw a flow of water into the pumping mechanism 2400, through at least a portion of the channel 2310, into and through at least a portion of the bins 2300, and out of the bins 2300 via the one or more openings (e.g., inlets/outlets) thereof. In other words, the pumping mechanism 2400 can be configured to push or urge a flow of water into and through the bins 2300 when in the second operating state and/or configuration (e.g., the downwelling configuration). The pumping mechanism 2400 can also have a second operating state and/or configuration in which the pumping mechanism 2400 is in an “off” state or the like. Accordingly, the pumping mechanism 2400 can be similar to and/or substantially the same as the pumping mechanism 1400 described above with reference to FIG. 1 and thus, not described in further detail herein.

As described above, the aquaculture system 2100 can include one or more buoyancy tanks 2500 for floatation. In some embodiments, the buoyancy tanks 2500 can be similar to or substantially the same as the buoyancy tanks 1500 described above with reference to FIG. 1. In some embodiments, the buoyancy tank(s) 2500 can be, for example, sealed container(s) disposed along the periphery and/or otherwise at the ends of the aquaculture system 2100. The one or more buoyancy tanks 2500 can be dimensioned to have a total volume such that if the volume is substantially filled with air at standard or atmospheric temperature and pressure, the resultant buoyant forces applied to the one or more buoyancy tanks 2500 (e.g., by the water in which the aquaculture system 2100 is disposed) is greater than a force associated with the total weight of the aquaculture system 2100. In some embodiments, the buoyancy tank 2500 can be configured to float the aquaculture system 2100 in an environment with substantially pure water (e.g., generally referred to a “fresh water” and/or water with a density of approximately 1000 kg/m3). For saltwater environments, the density of salt water is higher than fresh water, thus, buoyant forces applied to the buoyancy tank 2500 will be greater than the buoyant forces of substantially pure water (e.g., fresh water) and/or brackish water (e.g., a mixture of fresh water and salt water). An additional safety margin can be incorporated into the design of the buoyancy tank 2500 to ensure buoyant forces are also sufficient to counteract external forces applied to the aquaculture system 2100 during operation (e.g., tidal forces, ocean currents, wind, tension from the anchoring system 2600, etc.).

In some embodiments, the buoyancy tanks 2500 can be a rigid, thin-walled vessel whose shape and dimensions remain substantially unchanged when filled with air or water and can support pressurized fluids. In some embodiments, the buoyancy tanks 2500 can be an inflatable tank with deformable walls configured to withstand pressures greater than one atmosphere (atm). In other embodiments, the buoyancy tanks 2500 can include a substantially rigid exterior structure with a deformable or flexible bladder disposed in the substantially rigid exterior structure. Depending on the form factor, the buoyancy tank 2500 can be formed from various metals, polymers, composites, etc., including, but not limited to aluminum, steel, stainless steel, rubber, polyethylene, polyvinyl chloride, polycarbonates, poly(methyl methacrylate), fiberglass, carbon fiber, and/or the like. In some embodiments, the buoyancy tanks 2500 can be sealed once filled with air either during manufacture or during deployment.

In some embodiments, the aquaculture system 2100 can include a water pump (e.g., pumping mechanism 2400) configured to flow water into and/or out of the buoyancy tank 2500. In some embodiments, the pumping mechanism 2400 can be similar to or substantially the same as the pumping mechanism 1400 described above with reference to FIG. 1. In some embodiments, the aquaculture system 2100 can include a compressor or other pneumatic pumping device and a compressed air tank such that air from an external source or from the atmosphere (when the aquaculture system 2100 is not submerged) can be flowed into the compressed air tank for use later to displace water in the buoyancy tank 2500. In other embodiments, the aquaculture system 2100 can be configured to adjust and/or control an amount of buoyancy (e.g., float) of the buoyancy tank 2500 using only air. For example, in some embodiments, a volume of air contained in the buoyancy tank 2500 can be increased to increase buoyancy of the buoyancy thank 2500 or decreased to decrease buoyancy of the buoyancy tank 2500

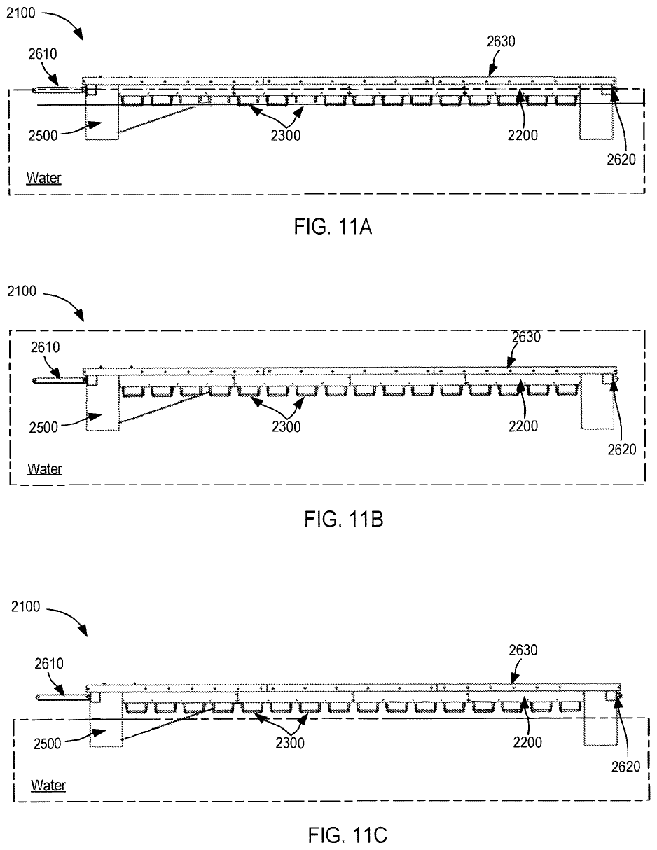

FIGS. 11A-11C show side views of the aquaculture system 2100 at various depths corresponding to different operating configurations. The buoyancy tanks 2500 can be filled with varying amounts of water and/or air to control the depth of the aquaculture system 2100. For example, FIG. 11A shows the aquaculture system 2100 in a growth configuration with the bins 2300 substantially submerged or at least partially submerged to allow a flow of water therethrough (e.g., in either an upwelling or downwelling direction). When in the growth configuration, the buoyancy tanks 2500, for example, can be at least partially filled with water such that a majority of each buoyancy tank 2500 is submerged below the surface of the water. FIG. 11B shows the aquaculture system 2100 entirely or fully submerged under water (e.g., below a surface of the water), which can be used during adverse weather conditions where the aquaculture system 2100 may otherwise be damaged by tidal forces and/or the like. The aquaculture system 2100 can also be submerged in order to protect or direct the development of the aquatic animals with regard to changing environmental conditions. In some embodiments, the aquaculture system 2100 can be submerged below a surface of the water at a depth between about 1 meter and about 10 meters. In some embodiments, the aquaculture system 2100 can include a sensor configured to detect a change in water quality and relay, in response to the change in water quality, a signal to a control system of the aquaculture system 2100 and/or service vessel 2700. In some embodiments, in response to this signal from the sensor, the control system can determine, using the processor, the memory, and/or a computer-readable media, a needed change to the submersion depth for the aquaculture system 2100. When in the submerged configuration, the buoyancy tanks 2500, for example, can be substantially filled or nearly filled with water such that each buoyancy tank 2500 is entirely submerged below the surface of the water. FIG. 11C shows the aquaculture system 2100 substantially raised from the water surface, which can be used to dry the aquatic animals prior to harvesting or during inspection or maintenance by a human operator. When in the drying/harvesting configuration, the buoyancy tanks 2500, for example, can be substantially devoid of water or can contain a relatively small amount of water such that a sufficient amount of each buoyancy tank 2500 is above the surface of the water to place the bins 2300 above the surface of the water.

### Service Vessel

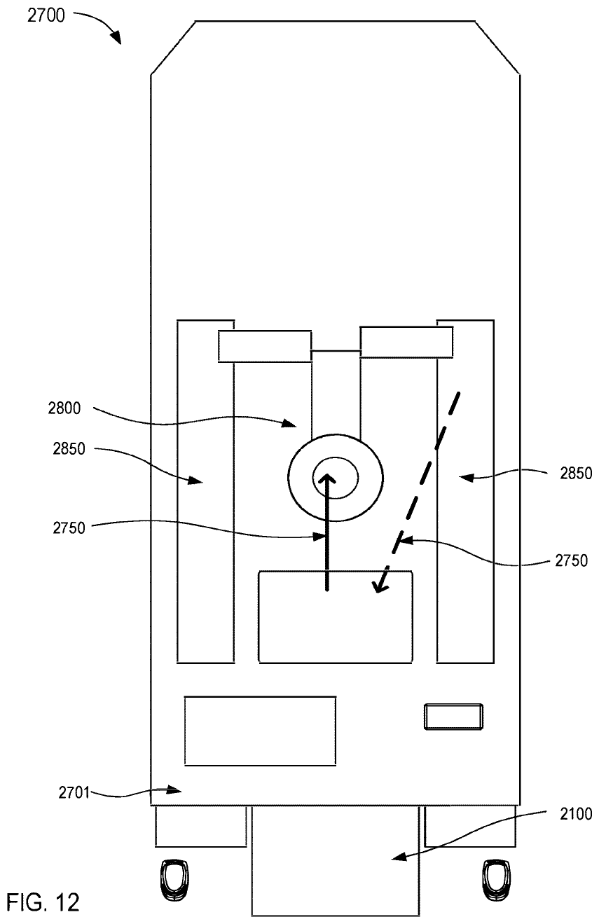

FIGS. 12-19 show details of the service vessel 2700 included in the cultivation system 2000. The service vessel 2700 can be configured to transfer, grade, and/or harvest aquatic animals. For example, in some implementations, the service vessel 2700 can be configured to transfer, grade, and/or harvest aquatic animals cultivated in an aquaculture system 2100. In some embodiments, one or more portions of the service vessel 2700 can be similar to or substantially the same as one or more corresponding portions of the service vessel 1700 described above with reference to FIGS. 1 and 2. Accordingly, such portions may not be described in further detail herein.

The service vessel 2700 can be any suitable floatable vessel, watercraft, boat, ship, raft, etc. that can be operated in or on a body of water to selectively engage and/or interact with one or more aquaculture systems 2100 that are disposed in that body of water. For example, the service vessel 2700 can be controlled (e.g., via human input or at least semi-autonomously) to place the service vessel 2700 near, adjacent, parallel to, and/or above one or more bins 2300 of the aquaculture system 2100 allowing one or more systems of the vessel 2700 to transfer aquatic animals therebetween. As shown in FIG. 12, the service vessel 2700 includes a deck 2701 and a set of hulls 2703. The deck 2701 can be any suitable shape, size, and/or configuration. In some embodiments, the service vessel 2700 can be a multi-hulled watercraft including at least two hulls 2703 that can allow the vessel 2700 to travel over, float over, and/or otherwise straddle one or more aquaculture systems 2100, providing access to the bins 2300 thereof. For example, the service vessel 2700 can be a catamaran, pontoon boat, or any other suitable floating vessel, craft, or vehicle having a pair of hulls 2703 on opposite sides of the vessel 2700. The deck 2701 can be disposed above and extend between the hulls 2703. The deck 2701 can provide one or more platforms to which equipment can be mounted and/or on which operator(s) of the service vessel 2700 can stand, walk, and/or otherwise operate the service vessel 2700.

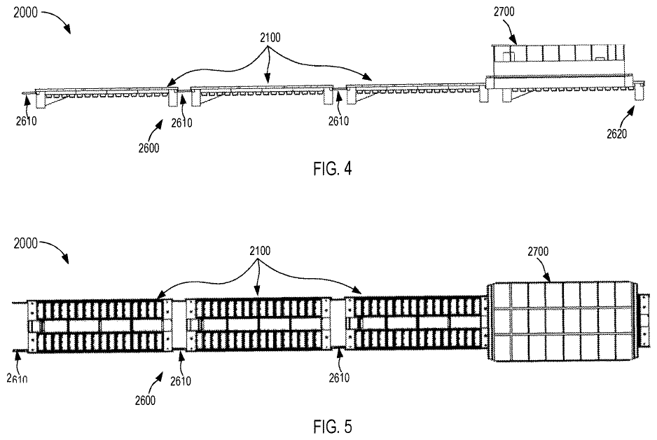

The service vessel 2700 can further include an enclosure or wheelhouse 2704 (see e.g., FIGS. 4 and 6) positioned on at least a portion of the deck 2701. In some embodiments, the enclosure and/or wheelhouse 2704 can extend along all or a majority of the deck 2701. In some embodiments, the wheelhouse 2704 can be a separate or sectioned off enclosure at, for example, a front (fore) portion of the deck 2701. The wheelhouse 2704 can include any suitable system, device, mechanism, computer and/or electronic system, communication system, and/or the like associated with operating, driving, and/or controlling at least a portion of the service vessel 2700. In some embodiments, the wheelhouse 2704 can include one or more of a power system and/or control system of the service vessel 2700 (not shown). For example, in some implementations, the roof or other structure of the enclosure or wheelhouse 2704 can include and/or can support any number of solar panels or the like configured to generate electrical power from sunlight. In some instances, an operator (e.g., a captain, a driver, etc.) can operate one or more systems or devices in the wheelhouse 2704 to drive the service vessel 2700 over one or more bins 2300 of the aquaculture system 2100 such that the one or more bins 2300 of the aquaculture system 2100 are positioned between the hulls 2703 and at least partially below the deck 2701 (see e.g., FIGS. 3-6). In some implementations, the control system (e.g., included in the wheelhouse 2704) can be similar to and/or substantially the same as the control system 1950 described above with reference to FIGS. 1 and 2. Accordingly, the control system of the service vessel 2700 is not described in further detail herein.

As shown in FIGS. 12-15, the service vessel 2700 can include a collection system 2750 (designated by an arrow in FIGS. 12-15), a grading/sorting system 2800, and a set of tanks 2850. Although not shown, the service vessel 2700 can also include a power system that can be and/or can include any suitable system or combination of systems configured to provide electrical power to one or more portions of the cultivation system 2000. In some embodiments, the power system can be similar to or substantially the same as the power system 1900 described above with reference to FIGS. 1-2B. In some embodiments, the power system can include an electrochemical device configured to store power and a power generation device (e.g., a photovoltaic system, a tidal current turbine system, and/or a wind turbine system). In some embodiments, the power system can be configured to generate and/or store sufficient energy such that the service vessel 2700 and the aquaculture system 2100 can operate, without power supplied from an external source, for an extended period such as, for example, greater than about 1 month, greater than about 6 months, greater than about 12 months, greater than about 24 months, greater than about 36 months, greater than about 48 months, greater than about 60 months (or period therebetween), or substantially for the lifespan of the service vessel 2700 and/or aquaculture system 2100.

In some embodiments, the power system can be configured to supply power to the aquaculture system 2100 to operate one or more systems and/or components thereof (e.g., the pumping mechanism 2400, the buoyancy tanks 2500, and/or the like). For example, the power system can include a power cable, power rail, and/or other suitable power connector allowing the aquaculture system 2100 to be in electrical communication with the power system disposed on or included in the service vessel 2700. In other implementations, the power system can be configured to charge an energy storage device (e.g., a battery) included in the aquaculture system 2100, which in turn, can provide electric power to the components of the aquaculture system 2100. In some implementations, the power system can be configured to provide power to the aquaculture system 2100 in a growing configuration, a dry configuration, and/or a submerged configuration (e.g., at submersion depths of greater than about 1 meter, greater than about 2 meters, greater than about 3 meters, greater than about 4 meters, greater than about 5 meters, greater than about 6 meters, greater than about 7 meters, greater than about 8 meters, greater than about 9 meters, greater than about 10 meters, or more (inclusive of all values and ranges therebetween).

In some embodiments, the power system can be configured to safely generate and/or store energy (e.g., via a battery or the like) sufficient to operate the at least one of the service vessel 2700 and/or the aquaculture system 2100. For example, the power system can generate electric power sufficient to operate the collection system 2750, the grading/sorting system 2800, and/or any other suitable system of the service vessel 2700. In some implementations, the power system can further provide electric power to the control system of the service vessel 2700 (not shown), which in turn, can control the systems and/or components of the service vessel 2700 (including the power system) and/or the systems and/or components of the aquaculture system 2100, as described above with reference to the control system 1950 illustrated in FIG. 2A. Accordingly, the control system is not described in further detail herein.

The collection system 2750 of the service vessel 2700 can be configured to transfer aquatic animals between the service vessel 2700 and one or more enclosures of the aquaculture system 2100 and/or one or more onshore or offshore facilities. The collection system 2750 can be coupled to the grading/sorting system 2800, which can be configured to grade, sort, and/or sample the aquatic animals based on one or more predetermined characteristics. The grading/sorting system 2800 can also be coupled to the set of tanks 2850 configured to contain, and/or store sorted aquatic animals. In some implementations, the collection system 2750 can be configured to collect from the set of tanks 2850 a portion of the aquatic animals disposed therein (such as those that do not have the predetermined characteristic(s) and/or that do not satisfy one or more predetermined criterion(ia)) and return them to the aquaculture system 2100. The vessel 2700 can also include a power system (not shown) and a control system (not shown) to supply power and monitor/control the different components on board the vessel 2700.

As described above, in some embodiments, the collection system 2750 can be configured to transfer aquatic animals between the service vessel 2700 and one or more enclosures or bins 2300 of the aquaculture system 2100. In some embodiments, the collection system 2750 can be similar to or substantially the same as the collection system 1750 described above with reference to FIG. 1. In some embodiments, the collection system 2750 can include a base, an arm support, one or more actuators, and an end effector. The base can be a structure or compression element configured to carry loads and provide mechanical support to the stationary and moving components of the collection system 2750. In some embodiments, the base can be a pedestal, footing, or foundation disposed on the deck of the service vessel 2700. The base can be fabricated from different materials including structural wood, steel plates, natural stone, concrete, reinforce concrete, and the like.

The arm support can be an articulated spar or boom that can facilitate movement of various components of the collection system relative to a desired portion of the aquaculture system 2100. The arm support can be mechanically coupled to the base via screws, bolt fasteners, welding, brazing, adhesives, or any combination thereof. In some embodiments, the arm support can include any number of components, mechanical linkages, couplers, joints, and/or the like including one or more links connected by a kinematic, rotary, and/or motor-actuated joints, and/or the like. As such, the arm support can be configured to provide various ranges of rotational and/or translational motion (with any number of degrees of freedom) allowing other components of the collection system 2750 to be placed in any number of desirable positions. In some embodiments, the arm support can be configured to accommodate one or more actuators. In some embodiments the arm support can be operated manually (e.g., via human input). In other implementations, the arm support device can be electronically, mechanically, pneumatically, and/or hydraulically controlled (e.g., in a programmable, semi-autonomous, and/or fully autonomous manner).

As described above, in some embodiments, the arm support can accommodate one or more actuators. The actuator can be any suitable mechanism that can be configured to execute a desired movement or positioning. As described above, the actuator can be coupled to the arm support using one or more tabs, brackets, mounts, flanges, and the like. In some embodiments, the actuator can be configured to produce linear movement and/or rotational movement. In some embodiments, the actuator can be mechanical, hydraulic, pneumatic, electromechanical, electrohydraulic, and/or magnetic. In some embodiments, the actuators can be controlled by the control system (not shown). The one or more actuators can be coupled to an end effector. The end effector can be any suitable member configured to engage and/or couple, and/or handle one or more removable bins 2300. In some embodiments the end effector can be an ingressive end effector configured to fit, attach to, lock-in, and/or penetrate one or more surfaces of the bin 2300.

For example, in some embodiments, the arm support can be a bent boom that includes a bottom arm and a length. The bottom arm can be disposed on the base via screws, bolt fasteners, welding, brazing, adhesives, or any combination thereof. The bottom arm can be mechanically coupled to the length using one or more tabs, brackets, mounts, flanges, and the like. The length can include two parallel plates or panels separated from each other a predetermined distance. The panels can be used to mount transversally a rod, shaft, strut or the like, configured to engage the hooks 2316 of the bins 2300 facilitating lifting and transporting and harvesting the aquatic animals contained in the bins 2300. The dimensions of the rod can be selected to fit the dimensions of the hooks in the removable bins 2300. In that manner, the collection system 2750 can be moved such that the rod engages and/or attaches to the hooks 2316 of the removable bins 2300. The bins 2300 can then be lifted from the aquaculture system and can be transported by the collection system to the grading/sorting system 2800. The aquatic animals stored in the bin 2300 can be transferred to the grading/sorting system by opening the lid 2304 of the bin 2300. In some embodiments the lid 2304 of the bin 2300 can be opened by gravity, while in other embodiments, the lid can be opened with the aid of a magnet. While the end effector is described above a rod, shaft, strut or the like that is configured to engage the hooks 2316 of the bins 2300, in other embodiments, the arrangement can be reversed. For example, the bins 2300 can include a rod, rail, shaft, strut, handle, etc. and the end effector of the collection system 2750 can be a hook or the like configured to hook on to the rod or the like.

In some embodiments, the collection system 2750 can be coupled to the grading/sorting system 2800 to collect the aquatic animals that do not meet the predetermined characteristics and/or do not satisfy the predetermined criteria, and to return them to the aquaculture system 2100. For example, in some embodiments, the collection system 2750 can be coupled to and/or at least partially disposed in the set of tanks 2850 to transfer at least some of the aquatic animals contained in the tanks 2850 to the aquaculture system 2100, as further discuss herein. In some embodiments, the collection system 2750 can be coupled to a conveyor system included in the grading and/sorting system 2800 to directly transport at least a portion of the aquatic animals sorted in a sorting device to the aquaculture system 2100 (e.g., that do not meet the predetermined characteristics). In other implementations, the collection system 2750 can be used to transport aquatic animals to one or more other storage members, holders, conveyers, etc. of a harvesting system or the like (e.g., not necessarily included in the service vessel 2700). For example, the collection system 2750 can be used to offload the sorted and collected aquatic animals at a processing facility or the like.

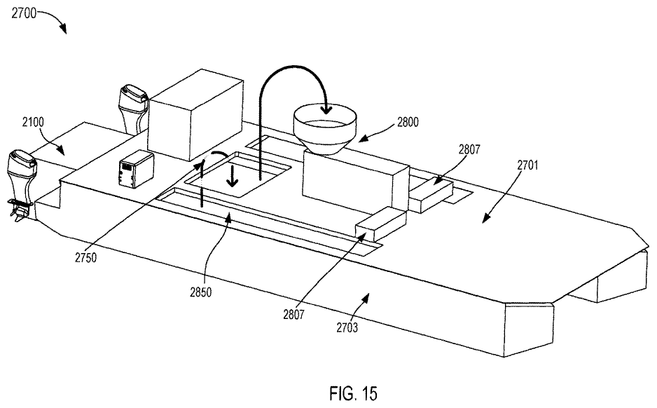

The grading/sorting system 2800 can be any suitable system or combination of systems configured to grade, sort, count, and/or sample aquatic animals. In some embodiments, the grading/sorting system 2800 can be similar to or substantially the same as the grading/sorting system 1800 described above with reference to FIG. 1. For example, in some instances, the grading/sorting system 2800 can be configured to grade and/or sort the aquatic animals (e.g., mollusks) based on one or more specified or predetermined characteristic(s), criterion(ia), and/or the like. In other instances, the grading/sorting system 2800 can be configured to obtain one or more subsets of aquatic animals selected randomly, or according to specific criteria. As shown in FIGS. 15-19, the grading/sorting system 2800 can include at least a hopper 2801, a sorting device 2802, a conveyor system 2806, and one or more counters/scanners 2808

The hopper 2801 of the grading/sorting system 2800 can be made from or of various materials including, but not limited to, stainless steel, aluminum, Ni—Cr, and/or any other suitable metal or metal alloy. The hopper 2801 can be coated with various coatings including, but not limited to polyamide, epoxy, polyurethane, neoprene, Rilsan, Nuflon, microbead, and/or the like to protect the aquatic animals from potential contamination. In other embodiments, the hopper 2801 can be made from or of any suitable polymer such as any of those described herein. The hopper 2801 can be coupled to the collection system 2750 and configured contain, store, aggregate, and/or otherwise transfer aquatic animals received from the collection system 2750. The hopper 2801 can also be coupled to the sorting device 2802 and configured to transfer the aquatic animals contained in the hopper 2801 to the sorting device 2802 for sorting, grading, and/or sampling subsets of aquatic animals according to one or more predetermined characteristic, such as size, shape, and/or geometry. In some embodiments, the hopper 2801 can include a vibrating feed, a pneumatic feed, a drum, an elevator, a storage tank, one or more inlets and/or outlets, and/or the like, as described above with reference to the grading/sorting system 1800 shown in FIG. 1.

In some embodiments, the hopper 2801 can be configured to reduce an amount of water transferred into the hopper 2801 as the aquatic animals (e.g., mollusks) are transferred to the hopper 2801. For example, the shape and/or configuration of the hopper 2801 can be such that the aquatic animals pass through the hopper 2801 to the sorting device 2802 while excess water is extracted and/or released from the hopper 2801. For example, the hopper 2801 can include one or more ports or the like that can be coupled to a vacuum pump (not shown), which in turn, can be used to create a pressure differential and/or a preferential flow of water through and/or around the hopper 2801 that allows the excess water to exit the hopper 2801 via the port.

As described above, the sorting device 2802 can be coupled to the hopper 2801 to receive, sort, grade, and/or sample aquatic animals according to predetermined characteristics. For example, in some instances, the sorting device 2802 can be configured to separate and/or sort the aquatic animals into one or more subsets of aquatic animals either randomly or according to predetermined characteristic such as having a minimum size and/or shape. In some instances, the sorting device 2802 can be configured to separate only aquatic animals that do not meet a specific characteristic such as a minimum size. In some implementations, the sorting device 2802 can be configured to grade and sort all the aquatic animals into different subgroups based on specific characteristics such as shape, weight, or relative size.

The sorting device 2802, for example, can be any suitable sorting device such as those described above with reference to grading/sorting system 1800 above. In some embodiments, for example, the sorting device 2802 can include a vibratory motor(s), and a set of screens, each of which having a different mesh, pore, and/or opening size and/or shape, configured to separate the aquatic animals (e.g., mollusks) into different groups according to the mollusks size, shape, weight, and/or the like. In some embodiments, the sorting device 2802 can include multiple separators, screens, sorters, etc. allowing the sorting device 2802 to separate and/or sort the aquatic animals into any number of separated groups or subsets based on desired characteristics and/or one or more predetermined criterion(ia).

In some implementations, the vibratory motor(s) can include an electric motor configured to rotate an unbalanced mass, thereby producing vibration. Moreover, the characteristics of the vibratory motor(s) (e.g., amount of mass, amount of unbalance, rotational velocity, torque, etc.) can be selected to provide a desired amount of vibration, vibration amplitude, vibration frequency, etc., and/or to hold at least a portion of the sorting device 2802 in resonance (i.e., at a frequency close to its natural frequency). In some embodiments, the sorting device 2802 can be coupled to a control system (not shown) configured to control and/or communicate with one or more portions of the vessel 2700. In some embodiments, such a control system can be configured to monitor and/or control one or more aspects, parameters, functions, and/or operations of the sorting device 2802 by executing and/or implementing user or operator provided input or instructions, an automated or semi-automated control algorithm, an artificial intelligence, machine learning, and/or adaptive algorithm or system, and/or the like.

In some embodiments, the sorting device 2802 can be coupled to a frame, which in turn, can be coupled to and/or includes an isolator element(s) configured to dampen the vibrations generated during operation of the sorting device 2802. The frame can be and/or can include one or more rigid, semi-rigid, and/or flexible structure(s) configured to provide mechanical support to the sorting device 2802 and/or the hopper 2801. In some embodiments, the frame can have dimensions sufficient to at least partially fit and/or support the hopper 2801 and sorting device. In some embodiments, at least a portion of the frame and/or support structure can be configured to dampen the vibrations generated during operation of the sorting device 2802. For example, the frame can include a set of coils or springs to prevent the propagation of vibrations produced during operation of the sorting device 2802. In addition, the frame can be coupled and/or anchored to an isolator element(s) to further suppress the propagation of vibrations from the sorting device 2802 to other components of the grading/sorting system 2800 and/or vessel 2700.

In some embodiments, the isolator element(s) can be and/or can include, for example, a thick mat disposed underneath the frame to dampen the vibrations. The isolator element can be made of various materials that exhibit a natural vibration frequency different (e.g., above or below) the vibration frequency of the sorting device. For example, the isolator element can be made of various materials including concrete, felt, rubber, cork, highly viscous fluid(s), and/or any other suitable vibration absorbing material or combinations thereof.

In some embodiments, the frame and/or the isolator element can include and/or can be coupled to one or more metal coils, dampeners, pneumatic cylinders, hydraulic cylinders, and/or the like. For example, in some embodiments the isolator element can include a set of gas struts (e.g., one or more gas struts) configured to reduce the propagation of the vibrations generated by the sorting device 2802. In some embodiments, the isolator element can include and/or can be coupled to, for example, four gas struts. The gas struts can be any suitable size, shape, and/or form. The gas struts can include various types of struts such as a fixed height cylinder, a spindle, a cable cylinder, a staged cylinder, a non-rotating cylinder, and/or the like and/or combinations thereof. The struts can include various features such as, for example, telescoping mechanisms for extending stroke, adjustable push-in force knobs or wires, degressive response mechanisms, and/or the like. The struts can include one or more tabs disposed along the length of the strut, which can function as mounting points to couple the struts to the isolation element. In some embodiments, a number of struts can be formed from a single component to simplify assembly.

The sorting device 2802 can be coupled to the conveyor system 2806 to transport and/or distribute the sorted aquatic animals to either the set of tanks 2850 or the collection system 2750 (e.g., for return to the aquaculture system 2100). More specifically, the sorting device 2802 can include, for example, an outlet or the like that can allow sorted aquatic animals to exit the sorting device 2802. In some embodiments, the sorting device 2802 can include an outlet manifold (not shown) that can direct the sorted aquatic animals to additional components of the grading/sorting system 2800 such as, for example, the conveyer system 2806. More particularly, the outlet manifold can include multiple channels, tubes, chutes, tracks, ports, and/or structures, each of which receives a sorted subset of the aquatic animals (e.g., based on size, shape, weight, etc.). In some embodiments, for example, the sorting device 2802 can be configured to sort aquatic animals into six sorted subsets of aquatic animals (e.g., mollusks) based on a desired and/or predetermined characteristic and/or criteria. Once sorted and/or separated, the sorted/separated aquatic animals can exit the sorting device 2802 via one outlet of the outlet manifold according to the sorting and/or separating criterion(ia). Thus, the outlet manifold, that can provide a corresponding number of structures configured to provide the separated or sorted aquatic animals to different conveyers of the conveyer system based on the desired and/or predetermined characteristic and/or criteria.

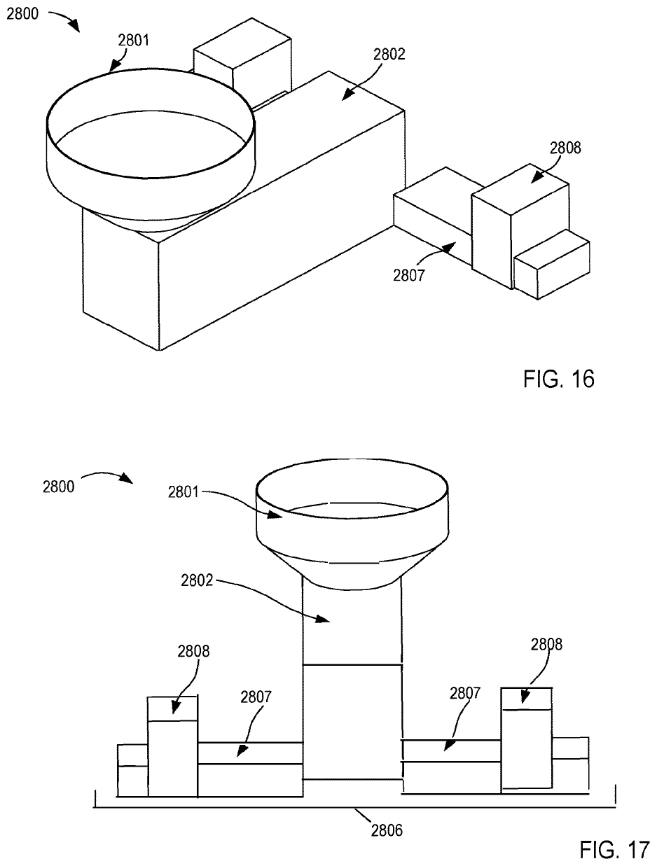

The conveyor system 2806 can be any suitable system or combination of systems configured to transport the sorted aquatic animals (e.g., mollusks). In some embodiments, the conveyor system 2806 can be coupled to the control system (not shown), configured to control and/or communicate with one or more portions of the conveyor system 2806 (e.g., via any suitable control algorithm(s), artificial intelligence algorithm(s), machine learning algorithm(s) , and/or the like. In some embodiments, the conveyor system 2806 can include one or more conveyors 2807 such as, for example, belt conveyors, chain conveyors, pneumatic conveyors, flexible conveyors, line shaft roller conveyor, screw or auger conveyors, and/or the like. More specifically, as shown in FIGS. 16-19, the conveyor system 2806 can include one or more belt conveyors 2807 coupled to the sorting device 2802 to transport the sorted aquatic animals away from the sorting device 2802. Although not shown, each conveyer 2807 can be coupled to and/or aligned with a different outlet or different structure of the outlet manifold of the sorting device 2802. In this manner, each conveyer 2807 can receive a sorted subset of the aquatic animals based on the predetermined characteristic and/or criteria (e.g., size, shape, weight, etc.). The conveyors 2807, in turn, are configured to convey the corresponding sorted subset of aquatic animals to either the set of tanks 2850 or to the collection system 2750, facilitating collection of the aquatic animals and/or the return of the aquatic animals that do not meet the predetermined characteristics to the aquaculture system 2100.

In some embodiments, the conveyors 2807 are configured to convey the corresponding sorted subset of aquatic animals to or past one or more counters/scanners 2808 configured to count and/or otherwise scan the number of aquatic animals sorted prior to conveying the aquatic animals to the set of tanks 2850 and/or the collection system 2750. The conveyor system 2806 and/or each conveyor 2807 included therein can include one or more spreaders 2809 (e.g., a spreader for each conveyer) configured to place the aquatic animals in a desired configuration (see e.g., FIG. 19). In some embodiments, the spreaders 2809 can organize and/or spread the aquatic animals (e.g., consecutively in one or more lines) to facilitate counting with the scanners 2808, as described in further detail herein. In some embodiments, the spreaders 2809 can be and/or can include any number of flexible, semi-rigid, or rigid tines, fingers, protrusions, etc., that can selectively engage the aquatic animals as they advance along the conveyors 2807 prior to entering and/or otherwise passing the scanners 2808.

In some embodiments, the spreaders 2809 can be coupled to and/or can include one or more sensors configured to sense and/or detect one or more characteristics associated with the aquatic animals. For example, in some instances, the tines, fingers, protrusions, etc. (referred to herein for simplicity as “tines”) can be moved, rotated, and/or transitioned in response to contacting an aquatic animal. The movement, rotation, and/or transition of the tines can be sensed and/or detected by the one or more sensors and data (e.g., physical and/or “contact” data) associated with an output of the sensor(s) can be analyzed (e.g., by the control system, an analysis unit, and/or other compute device) to determine and/or confirm whether the aquatic animals satisfy and/or meet the predetermined criterion(ia) associated with that subset of aquatic animals. In other words, data output by the one or more sensors can be analyzed to determine whether the aquatic animals transferred to that conveyer 2807 are the expected size and/or shape or are within an acceptable range of sizes and/or shapes. In other embodiments, the conveyor system 2806 need not include such sensors.

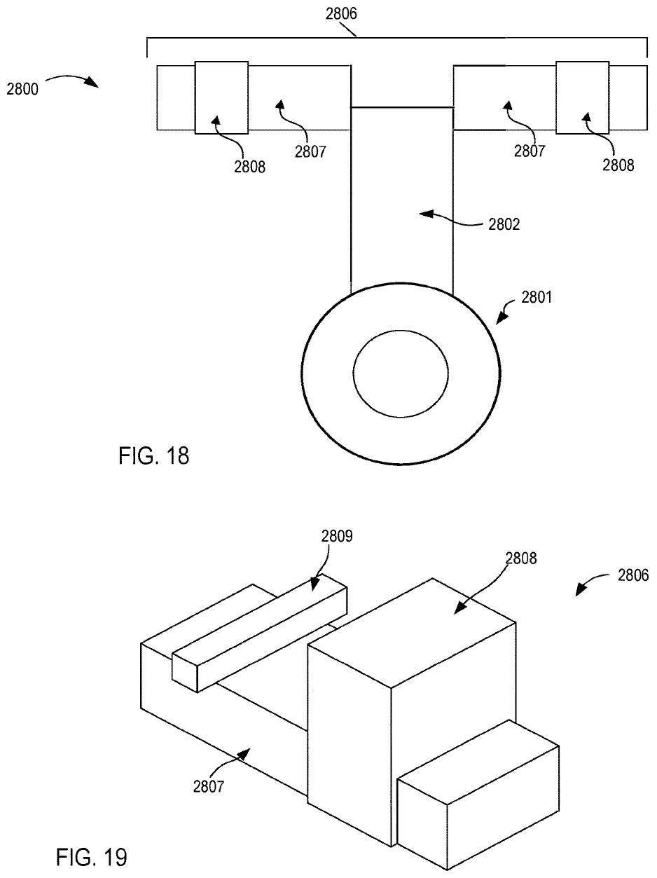

The counters/scanners 2808 (referred to for simplicity as “scanners 2808”) can be any suitable device, system, and/or mechanism configured to count and/or scan the aquatic animals graded, sorted, and/or sampled. In some embodiments, the counters/scanners 2808 can be similar to and/or substantially the same as the optical sensor(s) 1808 described above with reference to FIGS. 2A and 2B. In some embodiments, the counters/scanners 2808 can include the optical sensor(s) 1808 described above, as well as any other suitable component. In some embodiments, the scanner 2808 can be coupled to each of the conveyors 2807 of the conveyor system 2806 (see e.g., FIGS. 18 and 19). In some embodiments, scanners 2808 can be, for example, optical counter scanners such as, for example, light blocking counters, light scattering counters, direct imaging counters, and/or the like. In some embodiments, each scanner 2808 can be and/or can include, for example, at least one high-speed camera configured to capture or record images and/or other data from one or more viewing angles.

In some embodiments, an image acquisition and/or image analysis unit can be configured to execute any suitable analysis software, process, and/or method to provide high-speed counting with high accuracy. For example, in some implementations, the analysis software (executed by the control system, analysis unit, and/or other compute device) can perform and/or execute one or more processes, functions, models, and/or methods associated with identifying and/or recognizing the aquatic animals and/or characteristics thereof, assessing whether the aquatic animals satisfy one or more predetermined criterion(ia) and/or otherwise classifying and/or labeling the aquatic animals based on the predetermined criterion(ia), counting a number of the aquatic animals that satisfy the one or more predetermined criterion(ia), and/or any other suitable processes. As described in further detail herein, in some implementations, the analysis software and/or the like can be and/or can include a machine learning model, computer vision model, etc. configured to identify and/or classify the aquatic animals based on a set of characteristics associated with the aquatic animals, which in turn, can allow the identified and/or classified aquatic animals to be counted.

As described the conveyors 2807 can be configured to convey the sorted, counted, and scanned aquatic animals to a corresponding tank 2850 from the set of tanks 2850 and/or to the collection system 2750. In this manner, each tank 2850 can be coupled to and/or aligned with a separate conveyor 2807 of the conveyor system 2806 and configured to receive, contain, and/or store at least some of the aquatic animals sorted by the grading/sorting system 2800 (see e.g., FIGS. 12-15)

In some embodiments, the tanks 2850 can be disposed in and/or formed by the hulls 2703 of the service vessel 2700 and/or portion(s) thereof. The set of tanks 2850 can be any suitable shape and/or size. For example, a size and/or shape of the tanks 2850 can be at least partially based on a size, and/or shape of the hull 2703 in which is disposed of by which it is formed. The set of tanks 2850 can be dimensioned to contain a desired number of aquatic animals. For example, in some embodiments, the set of tanks 2850 can be sufficiently large and/or can otherwise have or form a collective volume that is sufficient to contain the aquatic animals transferred from the aquaculture system 2100 when the aquaculture system 2100 is at a maximum capacity. Moreover, the set of tanks 2850 can be configured to contain, for example, at least a minimum amount of water and/or liquid solution to facilitate preserving the aquatic animals disposed therein.

Although not shown, the set of tanks 2850 can include a water recirculation system with one or more bio-filters, sand filters, and/or ultra-violet filters to purify, clean, and/or sterilize the water and preserve the aquatic animals. The set of tanks 2850 can also include a valve, inlet, or port (not shown) configured to allow a flow of liquid into or out of the tanks 2850 (e.g., to at least partially fill one or more tanks 2850 with water, collect samples of water for quality control purposes, and/or the like). In some embodiments, the tanks 2850 can have a tapered and/or funnel-like shape that can facilitate a relatively uniform distribution of aquatic animals therein. In some embodiments, the tanks 2850 can include, for example, an outlet or the like that can be transitioned from a closed state to an open state to allow the aquatic animals to be quickly released and/or otherwise transferred from the tanks 2850 (e.g., at a harvesting or offloading facility and/or the like). In other embodiments, the tanks 2850 need not include such an outlet. In such embodiments, for example, the aquatic animals can be released, removed, harvested, and/or offloaded via the collection system 2750, as described in further detail herein.

As described above, the service vessel 2700 can include a control system, image acquisition and/or analysis unit, and/or any other suitable compute device(s) configured to process image data associated with aquatic animals as the conveyor system 2806 transfers graded and/or sorted aquatic animals from the sorting device 2807 to one of the tanks 2850. For example, in some implementations, the control system, analysis unit, etc. can include and/or can execute any suitable portion of the machine learning model 1956 described above with reference to FIG. 2B to process image data generated by the counters/scanners 2808. In such implementations, the machine learning model can be executed to identifying characteristics and/or features of the aquatic animals depicted in the image data, classify the aquatic animals based on the characteristics and/or features (e.g., a positive identification/determination of an aquatic animal), and count at least a subset of the aquatic animals based on the classification (e.g., count the positively identified aquatic animals).

In some instances, the image data generated by the counters/scanners 2808 can be used in conjunction with, for example, physical and/or contact data generated by the one or more sensors of the spreaders 2809 to identify and/or count the aquatic animals. In some implementations, the contact data can be used, for example, to confirm the data output by a machine learning or computer vision model used to identify and/or count the aquatic animals. In some implementations, the contact data can provide be provided as input into the machine learning model and used to describe and/or define initial conditions, parameters, calibrations, estimates, predicted outcomes, and/or any other suitable information. For example, in some instances, the contact data can include information associated with the average size of the aquatic animals, the density of a set or subset of the aquatic animals, an initial estimated count of the aquatic animals (or sorted subset thereof), and/or any of information. As such, the contact data can be used to calibrate, tune, adjust, initialize, etc. the machine learning model, which in turn, can increase an accuracy associated with an output of the machine learning model (e.g., increase an accuracy of a count of the aquatic animals). In other instances, the image data can be processed to count aquatic animals without the use of the additional “contact” data.

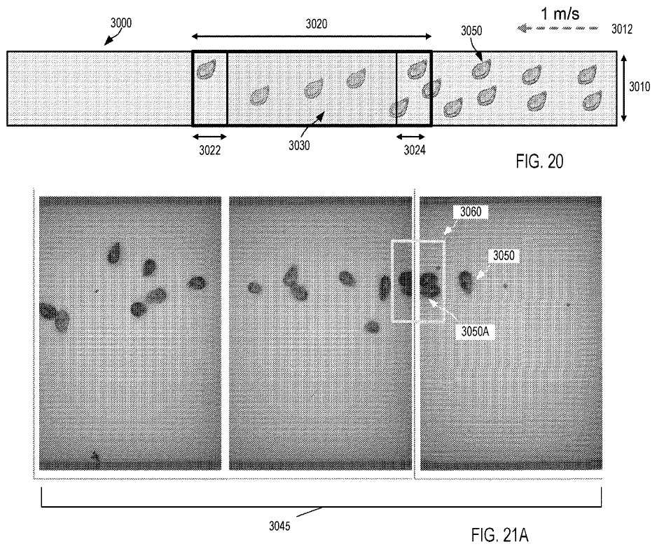

FIGS. 20-24C depict examples of methods of using a counter/scanner and conveyor system as described with respect to FIGS. 16-19 to capture image data associated with aquatic animals that have been graded and/or sorted by a grading/sorting system and to process the image data (e.g., using machine learning, computer vision, etc.) to identify and/or count at least a subset of the aquatic animals. For example, FIG. 20 is a schematic diagram of a conveyor system (e.g., the conveyor system 2806 described above with reference to FIGS. 16-19) including a conveyor 3000 (e.g., such as the convey 2807) and an enclosure 3020 having disposed therein one or more optical sensors (not shown). The conveyor 3000 may be configured to move a set of aquatic animals 3050 (e.g., oysters) at a predetermined rate 3012 through the enclosure 3020. In some embodiments, the conveyor 3000 may have a width 3010 of 1 foot (ft) or 0.3048 meters (m). In other embodiments, the conveyor 3000 may have a width up to about 1.0 meter (m). In some implementations, the conveyor 3000 may be configured to move at a rate of up to about 1 meter per second (m/s). In some embodiments, a rate of image capture may be synchronized to a speed of the conveyor 3000 using, for example, an encoder and/or any other sensor, detector, etc., as described in further detail herein. In some embodiments, a color of the conveyor 3000 may be selected to create a natural contrast relative to the aquatic animals 3050 disposed on the conveyor 3000. For example, the conveyor 3000 or a portion thereof may be a predetermined shade of blue that forms a sharp contrast against clams, oysters, etc. that can be generally light beige in color. Accordingly, the aquatic animals depicted in an image may be concentrated in a foreground of the image.

The one or more optical sensors disposed in the enclosure 3020 can be similar to or the same as the optical sensors and/or counters/scanners 1808 and 2808 described above. In some embodiments, the enclosure 3020 can protect the one or more optical sensors and/or can form and/or define an environment suitable for capturing image data. For example, in some embodiments, the enclosure 3020 can include an isolation element, damper, and/or any other suitable feature or device configured to reduce vibration and/or the like that otherwise may reduce a quality of the image data captured by the optical sensor(s) disposed in the enclosure 3020, as described above.

In some embodiments, the enclosure 3020 may be opaque to reduce ambient illumination within the enclosure 3020. In some embodiments, the enclosure 3020 may include one or more illumination sources (not shown in FIG. 20) configured to illuminate the set of aquatic animals 3050 for imaging. In some embodiments, a desired amount of illumination may be based at least in part on a speed or rate of the conveyor 3000. In some embodiments, the one or more illumination sources may be configured to generate up to about 70,000 lumens. By way of example, an illumination source can be configured to output or generate about 65,832 lumens. In this example, the illumination source can include a number of light emitting diode (LED) strips configured to output 422 lumens/foot and configured to illuminate 266 square inches (sqi) to 593 sqi of conveyor surface. In other implementations, high-efficiency LED strips may be used that output up to about 165 lumens/watt. In some embodiments, the illumination source may include a diffuser (e.g., frosted polycarbonate diffuser and/or any other suitable diffuser) to increase the homogeneity of the illumination and background (e.g., conveyor belt 3000) within the enclosure 3020, and thus increase image data quality. In some embodiments, the illumination source may be configured to generate illumination to improve image quality for predicting and/or detecting a set of characteristics of a set of aquatic animals, and/or for counting at least a portion of the aquatic animals depicted in the image.

The one or more optical sensors can generate and/or capture an image(s) corresponding to field of view of the optical sensor. In some embodiments, the field of view can correspond to a predetermined portion 3030 of the conveyor belt 3000 as it passes through the enclosure 3020. In some embodiments, for example, the field of view can correspond to substantially the entire width 3010 of the conveyor 3000 and a length of about 0.25 m of the conveyer 3000 (e.g., the predetermined portion 3030 is about 0.25 m long). As shown in FIG. 20, portions 3022 and 3024 can correspond to non-imaged areas within the enclosure 3020. In some implementations, the image data can be one or more images and/or one or more image frames of a video captured or recorded by the optical sensor. For example, the one or more optical sensors may be configured to capture image data depicting aquatic animals 3050 as they are moved along the conveyor 3000 within the enclosure 3020 and through or past the field of view of the optical sensor(s) (e.g., on or along the predetermined portion 3030 of the conveyor 3000). The images and/or image frames can, for example, depict at least a portion of the aquatic animals 3050 after the grading/sorting system (e.g., the grading/sorting system 2800) has graded and/or sorted the aquatic animals 3050 and as the aquatic animals 3050 are carried along the conveyor 3000 toward one or more tanks (e.g., the tanks 2850), as shown in FIG. 20.

As described above, the image data captured and/or generated by the optical sensor(s) can be processed using one or more machine learning models, computer vision models, AI models, and/or the like. In some implementations, the image data may be pre-processed to improve the quality of the image data for prediction and/or classification by, for example, removing extraneous and/or unrelated features (e.g., the conveyor 3000, fluid, background objects, artifacts, and/or the like). The image data may be pre-processed using one or more signal processing techniques. For example, a background of an image (e.g., the conveyor 3000) may be homogenized while increasing a contrast of foreground objects (e.g., aquatic animals of interest 3050). In some implementations, the conveyor 3000 can be configured with a color that produces a homogenous background in the image data allowing the aquatic animals 3050 to be concentrated in the foreground, which can reduce a need or desire for pre-processing. For example, a color of the conveyor 3000 may be selected to create a natural contrast relative to the aquatic animals 3050 disposed on the conveyor 3000 such as, for example, a predetermined shade of blue and/or other color that forms a sharp contrast against clams, oysters, etc. that generally are light beige in color. Accordingly, the aquatic animals 3050 depicted in an image may be concentrated in a foreground of the image, which in turn, can enhance the detection and/or classification of the model(s).

Any suitable machine learning model and/or combination of machine learning models can be implemented to process the image data generated and/or captured by the optical sensor(s). For example, the machine learning model(s) may be and/or may be based on one or more of a deep learning model, Faster R-CNN, CenterNet CNN, SSD, and/or combinations thereof, as described above. In some embodiments, the machine learning model can be executed to predict, determine, and/or identify a set of characteristics associated with the set of aquatic animals based on the image data and to identify and/or classify each aquatic animal based on the set of characteristics. In some implementations, the classification of the aquatic animals can allow for an accurate count of the aquatic animals based at least in part on the classification.

For example, the predicted and/or determined set of characteristics can include but is not limited to one or more of mortality, health, developmental stage, quantity, size, shape, geometry, weight, combinations thereof, and/or the like. In some embodiments, predicting and/or determining the set of characteristics of the set of aquatic animals can include identifying a subset of aquatic animals depicted in the image data that are boundary aquatic animals or aquatic animals disposed along one or more boundaries of one or more images, as described in further detail herein. In some embodiments, each aquatic animal may be classified based on the predicted and/or determined set of characteristics. The classification can be, for example, a label or other form of identification. In some embodiments, the classification can be one of a positive identification of an aquatic animal of interest (e.g., oyster), an identification of a boundary aquatic animal (e.g., an aquatic animal of interest depicted along an edge or boundary of one or more images), an identification of a healthy, unhealthy, and/or dead aquatic animal of interest, an identification of a non-target object (e.g., a negative identification associated with an object that is not an aquatic animal of interest), and/or any other suitable classification. In some embodiments, the set of characteristics can include a size range or grade of aquatic animals and the classification can be a positive identification of aquatic animals of interest having approximately the desired size or grade.

In some embodiments, the machine learning model(s) described herein can be trained and/or optimized for high recall for images containing, for example, relatively large numbers of relatively small objects having a high density. For example, the machine learning models can be trained to identify and/or classify oyster spats having a size smaller than about 1 centimeter (cm) (e.g., as small as about 2 millimeters (mm)) in an image containing, for example, over one thousand oysters or oyster spats. In some embodiments, a machine learning model may be trained using a machine learning model training data set that includes annotated images and/or image data. The training images and/or image data can be tuned to have a desired set of parameters that can increase recall of the machine learning model(s). For example, training of any of the machine learning models described herein can including tuning parameters such as, for example, setting an Intersection over Union to over 0.9 to facilitate counting of each oyster within a clump, setting a height and width stride to a relatively low value (e.g., 12 for 751-pixel-wide images), or setting a maximum number of detections (including both total and per object class) to about 2,000.

In some implementations, a machine learning model such as a Faster R-CNN model can be used to determine characteristics associated with the set of aquatic animals that includes decomposing the image data into regions of interest (ROI) that potentially contain objects through a selective search algorithm. Each ROI, in turn, can be analyzed using the convolutional neural networks to characterize the aquatic animals and this output can be compared against a training dataset to identify and/or classify the aquatic animals (e.g., oyster, shell, dead oyster, mussel, boundary oyster, etc.). In some instances, implementing a machine learning model that can detect and/or extract objects from a ROI (e.g., aquatic animals of interest), may be desirable for images that contain high numbers and high densities of objects to be identified, including smaller objects such as oyster spats. In some embodiments, the machine learning model can be trained for multi-scale/grade detection or for single scale/grade detection. For example, in some implementations a single Faster R-CNN model and/or any other suitable machine learning model can be trained for multi-scale detection or can be trained on a per grade (e.g., size class) basis, which in some instances, may promote a high recall suitable for detection of smaller aquatic animals such as oyster spats. In some embodiments, a Faster R-CNN model and/or other model configured to define an ROI can be trained to identify a subset of aquatic animals depicted in the image data in an ROI along an edge or boundary of one or more images and/or otherwise an ROI that spans across two or more images, as described in further detail herein.

In some implementations, a machine learning model such as an SSD model may be configured to partition a foreground and a background of an image in a single stage using sliding multi-scale detection boxes. As such, an SSD model can be configured to rapidly identify relatively larger oysters where each image includes a lower total number of oysters.

In some implementations, multiple machine learning models can be used to allow and/or provide greater accuracy associated with classifying and/or counting the aquatic animals. For example, an SSD model and/or any other suitable model can be used in conjunction with a Faster R-CNN model and/or any other suitable model. In some implementations, a set of machine learning models may be used hierarchically with individual machine learning models trained on a predetermined characteristic (e.g., predetermined range of animal size) and/or otherwise tuned for a desired type or form of object detection. In some implementations, a set of machine learning models may be used hierarchically with each individual model configured to predict and/or determine a subset of characteristics associated with the aquatic animals or aquatic animal lifecycle (e.g., mortality, arrested growth, biomass accumulation, health based on shell color, boundary animal, etc.).

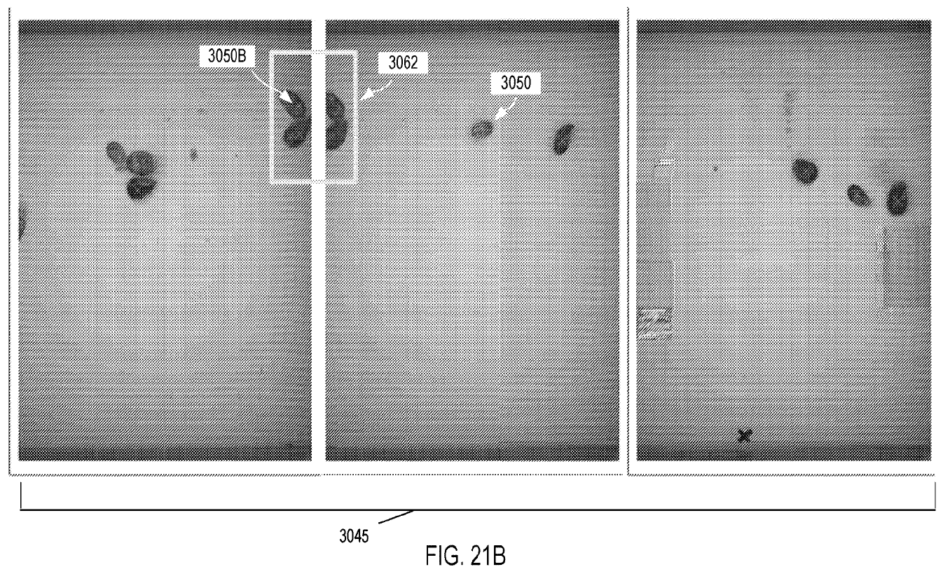

As described above, the machine learning models described herein can be executed to identify, classify, and/or count the aquatic animals 3050 (or at least a portion or set thereof) depicted in image data captured, for example, after the aquatic animals have been graded and/or sorted and as the aquatic animals are conveyed (e.g., on the conveyor 3000) toward one or more tanks. In some instances, however, accurate identification, classification, and/or counting of the aquatic animals 3050 depicted in the image data can be challenging when, for example, one or more aquatic animals 3050 is only partially imaged and/or that span(s) across two or more images (e.g., disposed along an edge or boundary of one or more images). For example, FIGS. 21A and 21B are a number of images 3045 depicting a number of the aquatic animals 3050 (e.g., oysters) with a subset of the aquatic animals disposed along one or more boundaries of the images 3045. As shown, a machine learning model (e.g., a Faster R-CNN model and/or any other suitable model) can process the data representing the images 3045 and can identify and/or define, for example, a first region of interest (ROI) or boundary box 3060 (FIG. 21A) and a second ROI or boundary box 3062 (FIG. 21B), each of which encompasses, circumscribes, and/or otherwise includes a subset of boundary aquatic animals 3050A and 3050B, respectively. As shown, the boundary aquatic animals 3050A and 3050B are disposed along an edge or boundary of one or more of the images 3045.

In some embodiments, the boundary aquatic animals 3050A, 3050B within the boundary box 3060, 3062 may be identified as an aquatic animal of interest (e.g., an aquatic animal 3050) based on a set of predetermined thresholds, characteristics, features, etc. For example, an aquatic animal within an image having a predetermined size ratio (e.g., length to width) may be identified as a “full” aquatic animal, while an aquatic animal below the predetermined size ratio may be identified as a “boundary” aquatic animal. In some instances, the machine learning model can be trained to reconstruct one or more of the boundary aquatic animals 3050A, 350B based at least in part on how close the boundary aquatic animal is to being classified as a “full” aquatic animal and/or based at least in part on an analysis of other images depicting the same boundary aquatic animal.

For example, the model can be configured to reconstruct boundary aquatic animals 3050A, 3050B by matching a boundary aquatic animal 3050A, 3050B represented in one image 3045 to a corresponding depiction of the full aquatic animal 3050 in a different image 3045 (e.g., based at least in part on a position and/or orientation of the aquatic animal, an expected and/or predicted position in subsequent images, and/or based on any other suitable criteria). In such implementations, reconstructing the boundary aquatic animals 3050A, 3050B based on the multiple images 3045 can ensure that boundary aquatic animals 3050A, 3050B are not counted as “full” aquatic animals 3050 in other images. That is to say, the images can be cross-referenced to ensure the aquatic animals (whether “full” and/or “boundary,” or any other classification) are only counted once.

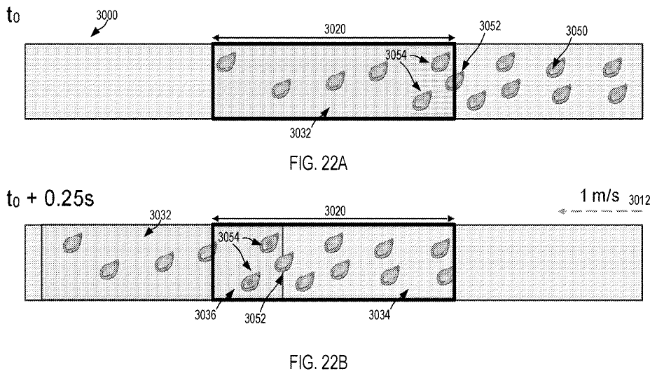

Additionally or alternatively, a boundary set of aquatic animals may be identified based on a correlation and/or relationship between a rate of movement of the aquatic animals and a rate of image capture by the one or more optical sensors. For example, FIGS. 22A and 22B are schematic diagrams of the conveyor 3000 and optical sensor(s) (not show) implemented to identify and/or classify boundary aquatic animals based at least in part on a relationship between the rate of the conveyor 3000 and the rate of image capture. More particularly, FIG. 22A shows the conveyor 3000 and aquatic animals 3050 at a first time t₀ and FIG. 22B shows the conveyor 3000 and aquatic animals 3050 at a second time t₁, 0.25 seconds(s) after the first time t₀ (e.g., t₀+0.25 s). In some instances, a first image 3032 may be captured by the optical sensor(s) within the enclosure 3020 at the first time t₀ and a second image 3034 may be captured by the optical sensor(s) within the enclosure 3020 at the second time t₁.

As shown in FIG. 22B, the first and second images are captured such that there is an overlapping portion 3036 depicted in the two images. More particularly, in some implementations, the optical sensor(s) can be configured such that one pixel of a captured image can correspond to 1 millimeter (mm) in distance. In some embodiments, the optical sensor(s) can have a focal length, aperture, and/or other parameters that can result, for example, in a field of view of about 0.35218 m in length (e.g., along relative to the conveyor 3000). As shown, the conveyor 3000 can be configured to move the aquatic animals 3050 relative to the optical sensor(s) at a rate of about 1 m/s. Thus, with the images being captured 0.25 seconds apart, the conveyor 3000 has moved the aquatic animals 3050 relative to the optical sensor(s) by about 0.25 meters (m). Moreover, with the field of view being 0.35218 m in length, the overlapping portion 3036 has a length of 0.35218 m-0.25 m or about 0.10218 m.

As shown in FIG. 22A, the first image depicts a boundary aquatic animal 3052, which is disposed at a boundary of the overlapping portion 3036 shown in FIG. 22B. As such, counting each of the aquatic animals depicted in the first image and the second image—excluding the boundary aquatic animal 3052—results in two aquatic animals 3054 being counted twice. Thus, in some implementations, it may be desirable to crop the first image 3032 and/or second image 3034 based on the rate of movement 3012 of the conveyor 3000 and the rate of image capture to reduce and/or prevent aquatic animals from being counted multiple times. Moreover, because the boundary aquatic animal 3052 is depicted on opposite boundaries in the first image 3032 and the second image 3034, the model can identify and/or classify the boundary aquatic animal 3052 and ensure that is only counted once.

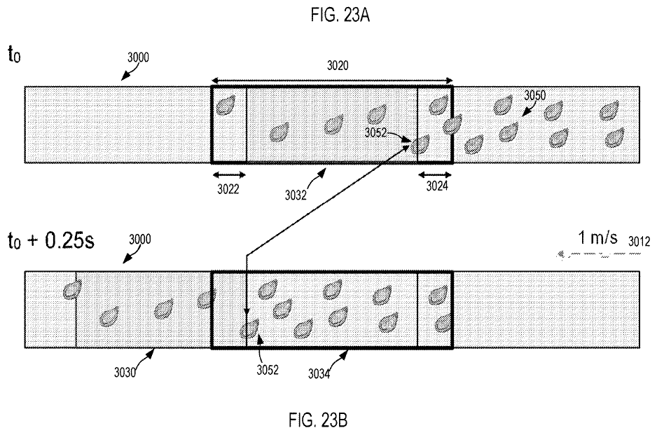

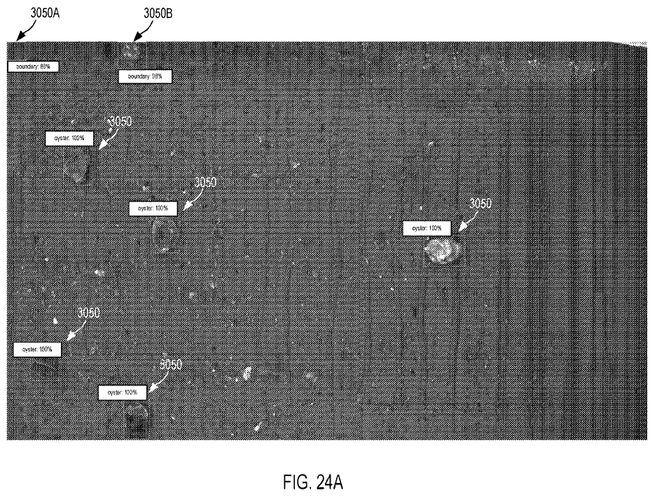

While FIGS. 22A and 22B show an overlapping portion 3036 at a trailing end of the enclosure 3020, in other implementations, the first image 3032 and/or second image 3034 can be cropped to reduce overlap. For example, FIGS. 23A and 23B show the first image 3032 and the second image 3034 being cropped at both ends. In some implementations, the cropping can be based at least in part on the rate of the conveyor 3000 and the rate of image capture. For example, the first image 3032 and the second image 3034 can be cropped such that the field of view depicted in the first image 3032 and the second image 3034 is 0.25 m long. As such, the boundary aquatic animal 3052 is depicted at opposite boundaries in the first image 3032 and the second image 3034 without other aquatic animals being depicted twice (e.g., as with the aquatic animals 3054 shown in FIGS. 22A and 22B). As described above, the model can identify and/or classify the boundary aquatic animal 3052 and ensure that is only counted once. Thus, a machine learning model can process any number of images and can use boundary aquatic animals in conjunction with a known relationship between the rate of the conveyor 3000 and the rate of image capture to define a region of interest (ROI) in which the aquatic animals 3050 can be counted for each image captured by the optical sensors. In some instances, such an implementation can allow for an accurate count of the aquatic animals in a relatively short period of time, which in turn, can allow for real-time or near real-time counting of the aquatic animals.

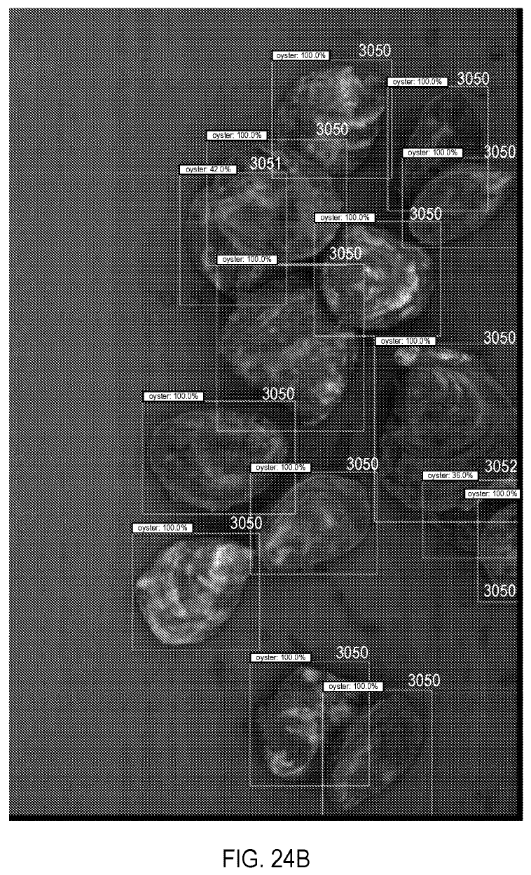

In some implementations, a classification can be based at least in part on satisfying a criterion(ia) and/or meeting/exceeding a threshold characteristic. For example, FIG. 24A illustrates an image processed by any of the machine learning models described herein and depicting a number of objects identified as aquatic animals of interest (“oyster: 100%), a first boundary object 3050A (“boundary: 89%), and a second boundary object 3050B (boundary: 98%). As described above, in some instances, the classification can be based at least in part on a size ratio (length/width). In some instances, the size ratio can be a threshold ratio and exceeding the threshold ratio can result in a “full” or affirmative classification, while failing to meet the threshold ratio can result in a “boundary” classification. In some instances, the model can determine the classification with a degree of certainty based on the size ratio and/or any other characteristic. For example, the first boundary object 3050A is depicted in such a manner that results in a classification with 89% certainty that the object is a boundary object (e.g., “boundary 89%,” as shown in FIG. 24A). The second boundary object 3050B is depicted in such a manner that results in a classification with 98% certainty that the object is a boundary object (e.g., “boundary 98%,” as shown in FIG. 24A). In this instance, other techniques such as those described herein may be used to confirm the classification of the boundary objects 3050A, 3050B and/or to provide additional data that could result in a change to the classification. In some instances, the “full” or affirmative classification can be such that each aquatic animals 3050 is counted, while the “boundary” classification can be such that the boundary objects 3050A, 3050B are not counted.

In some implementations, a classification can be based at least in part on a criterion being satisfied such as a threshold associated with “fullness” or “entirety” of the aquatic animals depicted. For example, FIG. 24B illustrates an image processed by any of the machine learning models described herein and depicting a number of objects arranged in a clump or grouping. In this example, the model can be implemented to determined and/or classify a degree of certainty or entirety of the aquatic animals depicted in the image. Moreover, in this example, one or more parameters can be tuned, selected, controlled, modified, etc. during training to increase precision and/or recall associated with identifying and/or classifying aquatic animals in such clumps or groupings.

In some implementations, the model can define classify the aquatic animals (e.g., oysters) based at least in part on a degree of “fullness” or “entirety” of the aquatic animal depicted in the image. In some instances, for example, the model can positively identify and/or classify an aquatic animal that is at least 20% full, at least 30%, at least 40% full, 50% full, at least 60% full, at least 70% full, at least 80% full, at least 90% full, at least 95% full, at least 99% full, or more, or any suitable percentage therebetween. As shown, a first subset of the objects are classified as aquatic animals 3050 (e.g., “oyster: 100%”), while a second subset of the objects are classified as aquatic animals 3051, 3052 with a degree of uncertainty (e.g., “oyster: 42.0%,” “oyster: 36.0%”). In some instances, a fullness, entirety, and/or certainty threshold can be defined as a parameter and/or criterion for counting the aquatic animals. For example, if the threshold is set at 40%, in the example shown in FIG. 24B, the aquatic animal 3051 (“oyster: 42.0%”) is counted (along with the aquatic animals receiving the 100% classification), while the aquatic animal 3052 (“oyster: 36.0%”) is not counted. In some instances, the degree of fullness, entirety, and/or certainty can be selected, adjusted, tuned, etc. to any suitable degree to allow the aquatic animals to be counted with a high degree of accuracy.

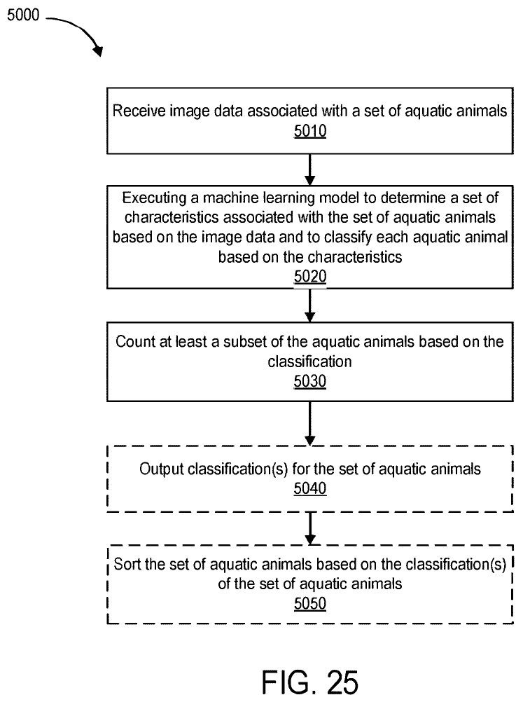

FIG. 25 is a flowchart depicting an illustrative embodiment of a method of classifying and/or counting aquatic animals (5000). In the embodiment depicted in FIG. 25, the method (5000) may include receiving image data associated with a set of aquatic animals (5010). In some embodiments, the image data may be generated by an optical sensor as described herein. The image data may include, for example, a single image or a number of images (e.g., a video). The image data may be in color, black and white, or combinations thereof. In some embodiments, the set of aquatic animals may be imaged while moving (e.g., on the conveyor 3000) relative to the optical sensor. Optionally, the received image data may be pre-processed to improve the quality of the image data for prediction and/or classification, for example, by removing extraneous and/or unrelated features (e.g., the conveyor system, fluid, background objects, artifacts, and/or the like), and/or performing any suitable pre-processing techniques, as described above.

In some embodiments, a machine learning model can be executed to predict, determine, and/or identify a set of characteristics associated with the set of aquatic animals based on the image data and to classify each aquatic animal based on the set of characteristics (5020). In some variations, the machine learning model may be and/or may be based on one or more of a deep learning model, Faster R-CNN, CenterNet CNN, SSD, and/or combinations thereof, as described above. In some embodiments, multiple machine learning models may be used hierarchically with individual machine learning models trained on a subset of characteristics, as described in detail above. In some embodiments, the machine learning model can be optimized for high recall for images containing, for example, relatively large numbers of relatively small objects having a high density, as described in detail above.

In some embodiments, the predicted and/or determined set of characteristics can include one or more of mortality, health, developmental stage, quantity, size, shape, geometry, weight, combinations thereof, or the like. In some embodiments, predicting and/or determining the set of characteristics of the set of aquatic animals can include identifying a subset of boundary aquatic animals, as described in detail above. In some embodiments, each aquatic animal may be classified based on the predicted and/or determined set of characteristics. The classification can be, for example, a label or other form of identification, such as any of those described herein.

Optionally, the classification(s) for the set of aquatic animals may be output (5040). In some embodiments, the classification(s) may be generated and output in real-time on one or more computing devices (remote or local devices), which can allow or facilitate an operator monitoring the health, status, count, etc. of the set of aquatic animals. Additionally or alternatively, the classification(s) may be stored in memory. Optionally, a trend of the classification(s) may be generated based on the classification(s) of the set of aquatic animals over time. For example, a plot of animal size over time may be generated and output on a display of a computing device. This may enable animal growth status to be monitored and analyzed over time. In some embodiments, the predicted and/or determined set of characteristics and/or classification(s) may be merged with other data sets (e.g., temperature, weather, nutrition, etc.) allowing for trend analysis of one or more data sets to provide holistic insight over time. In some embodiments, a graphical user interface (GUI) may be configured to output one or more of real-time classifications, historical classifications, classification trends, and/or the like. In some embodiments, the computing device can send, via any suitable network, signals and/or data representing instructions to cause any number of remote device(s) to present the GUI on one or more displays of that device or one or more displays controlled by that device. In some cases, the aquatic animal classifications and trends may be used to inform actions (autonomous actions by one or more devices or actions performed by human manipulation/intervention) to improve aquaculture and/or harvesting outcomes. For example, the results of an analysis may be used to generate one or more suggestions, prompts, and/or instructions associated with appropriate interventional steps (e.g., change in any number of parameters of the cultivation system), and/or the like.

Optionally, in some implementations, the set of aquatic animals may be sorted based on the classification(s) of the set of aquatic animals using a sorting device (5050). For example, while the optical sensor(s) are generally described herein as being coupled along a conveyor that transfers graded and/or sorted aquatic animals from a grading/sorting device to one or more tanks, in other embodiments, one or more optical sensors can be included at any suitable position along a collection chain from aquaculture system to tank. In some embodiments, for example, one or more optical sensors can capture image data of aquatic animals prior to the aquatic animals being transferred to the grading/sorting device. In such embodiments, the image data can be analyzed using any of the machine learning models and/or methods described herein, and the output of such analysis can be used, at least in part, to control, tune, and/or adjust the grading/sorting device. As such, aquatic animals can be sorted based at least in part on data associated with the classification(s) of the aquatic animals.

Optionally, in some embodiments, the grading/sorting system 1800 may comprise a contact sensor configured to generate physical or “contact” data associated with the set of aquatic animals. As described above, a processor of a control system and/or any suitable analysis unit can be configured to receive the contact data and can use the contact data in conjunction with the image data to determine the set of characteristics associated with the aquatic animals, to confirm the classification and/or count of the aquatic animals, to initialize and/or augment data provided as input into a machine learning and/or computer vision model, and/or the like.

While various implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the implementations described herein. More generally, those skilled in the art will readily appreciate that all parameters and configurations described herein are provided by way of example only and that other equivalents to the specific implementations described herein may be realized. It is, therefore, to be understood that the foregoing implementations are presented by way of example and that, within the scope of the appended claims and equivalents thereto, implementations may be practiced other than or in addition to those specifically described and claimed. Certain implementations of the present disclosure may be directed to each individual feature, system, article, and/or method described herein. In addition, any combination of two or more such features, systems, articles, and/or methods, if such features, systems, articles, and/or methods are not mutually inconsistent, is included within the scope of the present disclosure.

Where schematics and/or embodiments described above indicate certain components arranged in certain orientations or positions, the arrangement of components may be modified. While the embodiments have been particularly shown and described, it will be understood that various changes in form and details may be made. Although various embodiments have been described as having particular features and/or combinations of components, other embodiments are possible having a combination of any features and/or components from any of embodiments described herein.

The specific configurations of the various components can also be varied. For example, the size and specific shape of the various components can be different from the embodiments shown, while still providing the functions as described herein. More specifically, the size and shape of the various components can be specifically selected for a desired or intended usage. Thus, it should be understood that the size, shape, and/or arrangement of the embodiments and/or components thereof can be adapted for a given use unless the context explicitly states otherwise.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above.

While systems and methods are described herein as being implemented (at least in part) on a service vessel, it should be understood that classifying, grading, sorting, counting, etc. can be done at any suitable onshore and/or offshore facility. Alternatively, an onshore and/or offshore facility can perform the grading/sorting of oysters using known systems and/or processes and can include and/or implement just the optical sensor(s) and/or machine learning system(s) described herein to accurately count oysters, and/or vice versa. Moreover, in some instances, portions of the methods or systems for grading, sorting, classifying, counting, etc. can be performed at an onshore and/or offshore facility while other portions of such methods or systems can be performed on a service vessel. Accordingly, it should be understood that the concepts described herein are not intended to be limited to any particular embodiment or example presented herein unless expressly stated otherwise.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, an FPGA, an ASIC, and/or the like. Software modules (executed on hardware) can be expressed in a variety of software languages (e.g., computer code), including C, C++, Java™, Ruby, Visual Basic™, Python™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools, and/or combinations thereof (e.g., Python™). Additional examples of computer code include, but are not limited to, control signals, encrypted code, and compressed code. In some instances, software, hardware, or a combination thereof can be used in any suitable controller, control system, and/or the like implementing any suitable control scheme such as, for example, a proportional-integral-derivative (PID) controller, and/or the like.

What is claimed is:

1. A system, comprising:
an optical sensor configured to generate image data associated with a set of aquatic animals;
a memory; and
a processor operatively coupled to the memory and the optical sensor, the processor configured to:
receive the image data associated with the set of aquatic animals;
determine a set of characteristics associated with the set of aquatic animals based on the image data using a machine learning model;
classify each aquatic animal in the set of aquatic animals based on the set of characteristics using the machine learning model; and
count at least a subset of the aquatic animals based on the classification.
